(19) United States
(12) Patent Application Publication
(10) Pub. No.: US 2026/0302704 A1
(43) Pub. Date: Oct. 1, 2026

(54) SEPARABLE COMPONENTS IN WIRING DEVICES

(71) Applicant: Leviton Manufacturing Co., Inc., Melville, NY (US)

(72) Inventors: Ronald Jansen, Ridgewood, NY (US); Michael Kamor, North Massapequa, NY (US); Shuming Teoh, Huntington, NY (US); Neal Shah, Melville, NY (US)

(73) Assignee: Leviton Manufacturing Co., Inc., Melville, NY (US)

(21) Appl. No.: 19/477,196

(22) PCT Filed: Apr. 1, 2024
(86) PCT No.: PCT/US2024/022479

§ 371 Date: Oct. 21, 2025

Related U.S. Application Data
(60) Provisional application No. 63/462,605, filed on Apr. 28, 2023.
(60) Provisional application No. 63/598,640, filed on Nov. 14, 2023.

(51) Int. Cl. H01R 31/06; H01R 13/453; H01R 13/514; H01R 13/627; H01R 13/64; H01R 24/78; H01R 103/00

(52) U.S. Cl. CPC H01R 31/06; H01R 13/4532; H01R 13/514; H01R 13/6278; H01R 13/64; H01R 24/78; H01R 2103/00

(57) ABSTRACT

An electrical wiring device and methods of use thereof. The wiring device includes a base unit having an interior portion and defining an interior cavity. An electrical terminal is at least partially disposed in the interior portion of the housing. A removable insert or module is configured to be positioned at least partially within the interior cavity. The removable insert or module includes an electrical terminal configured to contact the electrical terminals positioned within the housing of the base unit. The wiring device further including a TR mechanism to prevent unintended access to the electrical terminals positioned within the housing of the base unit. In addition, and/or alternatively, the wiring device includes a module rejection feature configured to prevent an insert or module from being electrically coupled to a non-compatible base unit.

### CROSS-REFERENCE TO RELATED APPLICATIONS

This is a non-provisional of, and claims the benefit of the filing date of, U.S. provisional patent application No. 63/462,605, filed Apr. 28, 2023, entitled “Separable Components in Wiring Devices,” and is a non-provisional of, and claims the benefit of the filing date of, U.S. provisional patent application No. 63/598,640, filed Nov. 14, 2023, entitled “Separable Components in Wiring Devices,” the entirety of each application is incorporated by reference herein.

### TECHNICAL FIELD

The present disclosure is generally directed to electrical systems and/or components such as, for example, electrical wiring devices such as, for example, electrical outlets or receptacles, switches, 3-way switches, occupancy sensors, timers, and others, and, in particular, to wiring devices including separable components, modules, inserts, or the like, that may be used and/or inserted into base units for providing one or more electrical connections.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

A wiring device is disclosed. The wiring device includes a base unit and a removable module. The base unit is arranged and configured to be coupled within an electrical box within a building surface, the base unit including a housing defining an interior cavity including a front facing surface, the front facing surface including a plurality of openings. A plurality of electrical terminals are at least partially disposed within the housing, each of the plurality of electrical terminals is accessible via a corresponding one of the plurality of openings. The removable module is configured to be positioned at least partially within the interior cavity of the base unit, the removable module including a plurality of electrical terminals, wherein each of the plurality of electrical terminals of the removable module is configured to pass through a corresponding one of the plurality of openings of the base unit and into contact with a corresponding one of the plurality of electrical terminals positioned within the base unit. The wiring device further including a slider including a plurality of openings, a first surface, a second surface, and a third surface. The slider is positioned between the plurality of openings formed in the front facing surface of the interior cavity of the housing and the plurality of electrical terminals disposed within the housing. The slider is moveable between a first position, wherein the slider prevents access to the plurality of electrical terminals disposed in the base unit, and a second position, wherein the plurality of openings formed in the slider align with the plurality of openings formed in the front facing surface to enable the plurality of electrical terminals of the removable module to pass therethrough to contact the plurality of electrical terminals in the base unit. The slider is configured to move from the first position to the second position in response to a sequence of operations. The sequence of operations including a first electrical terminal of the plurality of electrical terminals of the removable module contacting the first surface of the slider to move the slider relative to the front facing surface by a predetermined distance. Movement of the slider by the predetermined distance causing the second and third surfaces of the slider to become exposed. The second and third surfaces of the slider becoming exposed allows a second electrical terminal of the plurality of electrical terminals of the removable module to contact the second surface and a third electrical terminal of the plurality of electrical terminals of the removable module to contact the third surface to move the slider to the second position.

In some embodiments, the first surface includes an angled surface with respect to a front surface of the slider such that contact with the first electrical terminal of the removable module causes the slider to move laterally relative to the front surface of the slider.

In some embodiments, in the first position, the second and third surfaces are inaccessible via the plurality of openings in the slider.

In some embodiments, the second and third electrical terminals contact the second and third surfaces simultaneously, respectively.

In some embodiments, the first electrical terminal of the removable module comprises a ground terminal.

In some embodiments, one of the second electrical terminal and the third electrical terminal of the removable module comprises a phase terminal, and the other of the second electrical terminal and the third electrical terminal comprises a neutral terminal.

In some embodiments, the wiring device further includes first and second lock surfaces.

In some embodiments, the first lock surface is configured to engage a first edge of the slider and the second lock surface is configured to engage a second edge of the slider.

In some embodiments, performance of the sequence of operations causes the slider to move without contacting the first and second lock surfaces.

In some embodiments, when the sequence of operations is not performed, the slider moves so that the slider contacts one of the first and second lock surfaces thereby preventing the slider from moving to the second position.

In some embodiments, insertion of a compatible removable module into the interior cavity of the housing of the base unit results in performance of the sequence of operations.

In some embodiments, insertion of one of a non-compatible removable module or a foreign object causes the slider to move into contact with one of the first and second lock surfaces.

In some embodiments, movement of the slider comprises rotation.

In some embodiments, the wiring device further includes a biasing member to bias the slider to the first position.

In some embodiments, the removable module includes a projection extending therefrom, the base unit includes an opening formed therein, wherein, for a compatible removable module, the projection is received by the opening formed in the base unit.

In some embodiments, the opening formed in the base unit prevents insertion of a non-compatible removable module.

In some embodiments, the wiring device further includes a block arranged and configured to engage the base to prevent access to one or more of the plurality of openings.

In some embodiments, the block includes a body portion and a boss, wherein at least one of the body portion or the boss are arranged and configured to be received within the one or more of the plurality of openings.

In some embodiments, the body portion further includes first and second arms arranged and configured to be received within first and second holes formed in the base unit.

An alternate embodiment of a wiring device is also disclosed. In some embodiments, the wiring device includes a base unit and a removable module. The base unit is arranged and configured to be coupled within an electrical box within a building surface, the base unit including a housing defining an interior cavity including a front facing surface, the front facing surface including a plurality of openings. A plurality of electrical terminals are at least partially disposed within the housing, wherein each of the plurality of electrical terminals is accessible via a corresponding one of the plurality of openings. The removable module is configured to be positioned at least partially within the interior cavity of the base unit, the removable module including a plurality of electrical terminals, wherein each of the plurality of electrical terminals of the removable module is configured to pass through a corresponding one of the plurality of openings of the base unit and into contact with a corresponding one of the plurality of electrical terminals positioned within the base unit. The removable module further includes a projection extending therefrom, the base unit includes an opening formed therein. In use, for a compatible removable module, the projection is received by the opening formed in the base unit, however, insertion of a non-compatible removable module is mechanically prevented.

A base unit of a wiring device is also disclosed. The base unit including a housing arranged and configured to be coupled within an electrical box within a building surface, the housing defining an interior cavity including a front facing surface including a plurality of openings, the housing further including a plurality of electrical terminals at least partially disposed within the housing, wherein each of the plurality of electrical terminals is accessible via a corresponding one of the plurality of openings, the housing further includes a slider including a plurality of openings, a first surface, a second surface, and a third surface. The interior cavity of the housing being arranged and configured to receive a removable module including a plurality of electrical terminals, wherein each of the plurality of electrical terminals of the removable module is configured to pass through a corresponding one of the plurality of openings formed in the front facing surface of the base unit to contact with a corresponding one of the plurality of electrical terminals positioned within the base unit. The slider being positioned between the plurality of openings formed in the front facing surface of the interior cavity and the plurality of electrical terminals. The slider is moveable between a first position, wherein the slider prevents access to the plurality of electrical terminals disposed in the base unit, and a second position, wherein the plurality of openings formed in the slider align with the plurality of openings formed in the front facing surface to enable the plurality of electrical terminals of the removable module to pass therethrough to contact the plurality of electrical terminals in the base unit. The slider is configured to move from the first position to the second position in response to a sequence of operations. The sequence of operations including contacting via a first electrical terminal of the plurality of electrical terminals of the removable module the first surface of the slider to move the slider relative to the front facing surface by a predetermined distance. Movement of the slider by the predetermined distance causing the second and third surfaces of the slider to become exposed, which enables contacting via a second electrical terminal of the plurality of electrical terminals of the removable module to contact the second surface and a third electrical terminal of the plurality of electrical terminals of the removable module to contact the third surface to move the slider to the second position.

Alternate embodiments of wiring devices are disclosed. In some embodiments, the wiring device includes a base unit and a removeable module. The base unit being arranged and configured to be coupled within an electrical box within a building surface, the base unit including a housing defining an interior cavity including a front facing surface including a plurality of openings. A plurality of electrical terminals are at least partially disposed within the housing, wherein each of the plurality of electrical terminals is accessible via a corresponding one of the plurality of openings. The removable module is configured to be positioned at least partially within the interior cavity of the base unit, the removable module including a plurality of electrical terminals, wherein each of the plurality of electrical terminals of the removable module is configured to pass through a corresponding one of the plurality of openings formed in the front facing surface of the base unit to contact a corresponding one of the plurality of electrical terminals positioned within the base unit. The wiring device further including a slider including a plurality of openings, a first surface, a second surface, and a third surface. The slider is positioned between the plurality of openings formed in the front facing surface of the interior cavity and the plurality of electrical terminals positioned within the base unit. The slider is moveable between a first position, wherein the slider prevents access to the plurality of electrical terminals disposed in the base unit, and a second position, wherein the plurality of openings formed in the slider align with the plurality of openings formed in the front facing surface to enable the plurality of electrical terminals of the removable module to pass therethrough to contact the plurality of electrical terminals in the base unit. The slider is configured to move from the first position to the second position in response to a sequence of operations. The sequence of operations including first and second electrical terminals of the plurality of electrical terminals of the removable module contacting the first and second surfaces of the slider to move the slider relative to the front facing surface in a first direction. A third electrical terminal of the plurality of electrical terminals of the removable module contacting the third surface to move the slider in a second direction, the second direction being different than the first direction.

In some embodiments, the second direction is substantially perpendicular to the first direction.

In some embodiments, the second direction is angled ninety-degrees relative to the first direction.

In some embodiments, the slider includes first and second protrusions, the first and second protrusions including the first and second surfaces, respectively, the first and second protrusions being accessible via first and second openings, respectively, of the plurality of openings formed in the front facing surface.

In some embodiments, the first and second protrusions each include a ramped surface formed thereon for contacting a corresponding ramped surface formed on the first and second electrical terminals of the removable module.

In some embodiments, the third electrical terminal extends horizontally relative to the first and second electrical terminals.

In some embodiments, the slider includes a third protrusion including the third surface formed thereon, the third protrusion being accessible via a third opening of the plurality of openings formed in the front facing surface In some embodiments, the third protrusion includes a ramped surface formed thereon for contacting a corresponding ramped surface formed on the third electrical terminal of the removable module.

In some embodiments, movement of the slider in the first direction causes the first and second protrusions to move out of contact with first and second abutting surfaces, respectively, formed on the front facing surface.

An alternate embodiments of a wall-box mounted wiring device is disclosed. The wiring device including a base unit and a removable module. The base unit being configured to be mounted within a wall-box. The base unit including a housing defining an interior cavity including a front facing surface having a plurality of base unit openings. The base unit being configured to receive a removable module at least partially within the interior cavity. A plurality of electrical terminals are at least partially disposed within the housing, wherein each of the plurality of electrical terminals is accessible via a corresponding one of the plurality of base unit openings. The wiring device further includes a slider having a plurality of slider openings and a plurality of slider contact surfaces arranged in a plurality of prescribed contact locations on the slider, each of the plurality of slider openings arranged and configured to be selectively aligned with a corresponding one of the plurality of base unit openings to permit the plurality of electrical terminals of the removable module to pass therethrough. The slider being movably positioned between the plurality of base unit openings and the plurality of electrical terminals. The slider is moveable between a first position and a second position to selectively prevent and permit, respectively, the plurality of electrical terminals to pass therethrough. The wiring device further includes a biasing member arranged and configured to bias the slider towards the first position when the removable module is not fully inserted into the interior cavity. In the first position at least one of the plurality of slider openings is not aligned with at least one of the plurality of base unit openings and in the second position each of the plurality of slider openings aligns with a corresponding one of the plurality of base unit openings. The slider is configured to be moved from the first position to the second position upon insertion of the removable module only if the plurality of electrical terminals are arranged and configured to fit through, and align with, the corresponding plurality of base unit openings and only upon the occurrence of at least two of the plurality of electrical terminals making physical contact with two of the corresponding prescribed contact locations of the plurality of prescribed contact locations in accordance with a prescribed contact sequence. The plurality of prescribed contact locations and the prescribed contact sequence are, defined by the arrangement and configuration of the plurality of base unit openings, the plurality of electrical terminals, the plurality of slider openings, and/or the plurality of slider contact surfaces. At least one of the plurality of prescribed contact surfaces is configured to interact with a corresponding first electrical terminal of the plurality of electrical terminals such that the slider is urged by such interaction to move from the first position to the second position when at least one other prescribed contact surface of the plurality of contact surfaces interacts with a corresponding second electrical terminal of the plurality of electrical terminals, wherein the first and second electrical terminals interact with corresponding prescribed contact surfaces in accordance with the prescribed contact sequence.

In some embodiments, the prescribed contact sequence includes the first electrical terminal interacts with the at least one of the plurality of prescribed contact surfaces to move the slider relative to the front facing surface by a predetermined distance. Movement of the slider by the predetermined distance causing the at least one other prescribed contact surface to become exposed so that the second electrical terminal of the plurality of electrical terminals contacts the at least one other prescribed contact surface to move the slider to the second position.

An alternate embodiments of a wall-box mounted wiring device is disclosed. The wiring device including a housing having a front facing surface, wherein the front facing surface includes a plurality of wiring device openings, an interior cavity, wherein the front facing surface is positioned within the interior cavity, an at least partially enclosed portion including a plurality of electrical terminals, wherein each of the electrical terminals is aligned with a respective wiring device opening, and a slider positioned between the plurality of wiring device openings and the plurality of electrical terminals. The slider includes a plurality of slider openings and a plurality of slider bearing surfaces, wherein each slider bearing surface is positioned at a respective bearing location on the slider. The slider is moveable between a first position and a second position, wherein the slider is biased towards the first position. The wiring device is configured to receive a removable module at least partially within the interior cavity, the removable module having a plurality of electrical terminals. When the slider is in the first position, the slider prevents the electrical terminals from touching the plurality of terminals. When the slider is in the second position, each of the slider openings is aligned with a respective wiring device opening. Alignment enables each of the electrical terminals of the removable module to pass through a respective slider opening to touch a respective electrical terminal. The slider is configured to be moved from the first position to the second position only in response to a predetermined sequence. The predetermined sequence including each of the plurality of electrical terminals aligns with a respective wiring device opening, a first electrical terminal of the plurality of electrical terminals exerts a first force on a first bearing surface of the plurality of bearing surfaces, and a second electrical terminal of the plurality of electrical terminals exerts a second force on a second bearing surface of the plurality of bearing surfaces. The first and second forces are exerted simultaneously to cause the slider to move from the first position to the second position.

In some embodiments, the sequence further includes the slider moving from the first position to an intermediate position in response to a third electrical terminal of the plurality of electrical terminals exerting a third force on a third bearing surface of the plurality of bearing surfaces.

In some embodiments, the sequence further includes the slider moving from the intermediate position to the second position in response to a fourth electrical terminal of the plurality of electrical terminals exerting a fourth force on a fourth bearing surface of the plurality of bearing surfaces.

In some embodiments, movement between the first position and the intermediate position occurs in a first direction and the movement between the intermediate position to the second position occurs in a second direction, wherein the first and second directions are parallel or perpendicular to each other.

Further features and advantages of at least some of the exemplary embodiments of the current subject matter, as well as the structure and operation of various exemplary embodiments of the current subject matter, are described in detail below with reference to the accompanying drawings.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a perspective view of an embodiment of a wiring device including a base unit and a removable module;

FIG. 2A illustrates a front view of an embodiment of a TR mechanism that may be used in the base unit of the wiring device shown in FIG. 1 in accordance with one or more features of the present disclosure, the TR mechanism illustrated in the first or rest position;

FIG. 2B illustrates a front view of the TR mechanism shown in FIG. 2A, the TR mechanism illustrated in an intermediate position;

FIG. 2C illustrates a cross-sectional view of the TR mechanism shown in FIG. 2B;

FIG. 2D illustrates a cross-sectional view of the TR mechanism shown in FIG. 2A, the TR mechanism illustrated in a second or opened position;

FIG. 2E illustrates a cross-sectional view of the TR mechanism shown in FIG. 2A, the TR mechanism illustrated in a locked position;

FIG. 2F illustrates an alternate cross-sectional view of the TR mechanism shown in FIG. 2A, the TR mechanism illustrated in an alternate locked position;

FIG. 2G illustrates an alternate cross-sectional view of the TR mechanism shown in FIG. 2A, the TR mechanism illustrated in a locked position;

FIG. 2H illustrates a perspective view of an embodiment of a TR mechanism (e.g., slider) in accordance with one or more features of the present disclosure;

FIG. 2I illustrates an alternate perspective view of the slider shown in FIG. 2H;

FIG. 2J illustrates a cross-sectional view of the slider shown in FIG. 2H;

FIG. 3A illustrates a perspective view of an alternate removable module that may be used in a base unit of a wiring device, the module arranged and configured to enable dual translation of a corresponding TR mechanism formed in the base unit of the wiring device;

FIG. 3B illustrates a side view of the removable module shown in FIG. 3A;

FIG. 3C illustrates a top view of the removable module shown in FIG. 3A;

FIG. 3D illustrates a perspective view of the dual translation TR mechanism that may be incorporated into the base unit of the wiring device, the TR mechanism arranged and configured to work with the removable module shown in FIG. 3A;

FIG. 3E illustrates a side view of the TR mechanism shown in FIG. 3D;

FIG. 3F illustrates a top view of the TR mechanism shown in FIG. 3D positioned within the base unit of a wiring device;

FIG. 3G illustrates an exploded, perspective view of the TR mechanism shown in FIG. 3F;

FIG. 3H illustrates a perspective view of the TR mechanism shown in FIG. 3D, the slider positioned in an intermediate position;

FIG. 3I illustrates an alternate perspective view of the TR mechanism shown in FIG. 3D, the slider positioned in an intermediate position;

FIGS. 3J-3Q illustrate various views of the TR mechanism shown in FIG. 3D; FIGS. 3J-3Q illustrating the sequence of steps utilized by a compatible module to move the TR mechanism from the first or rest position to the second or opened position;

FIG. 4A illustrates a front view of an embodiment of a base unit of a wiring device, the wiring device incorporating a module rejection feature or a module incompatible feature in accordance with one or more features of the present disclosure;

FIG. 4B illustrates a perspective view of an embodiment of a removable module incorporating a module rejection feature or a module incompatible feature in accordance with one or more features of the present disclosure;

FIG. 4C is a cross-sectional view illustrating the removable module shown in FIG. 4B inserted into the base unit shown in FIG. 4A;

FIG. 5A illustrates a front view of an alternate embodiment of a base unit of a wiring device, the wiring device incorporating an alternate module rejection feature or module incompatible feature in accordance with one or more features of the present disclosure;

FIG. 5B illustrates a perspective view of an alternate embodiment of a module incorporating an alternate module rejection feature or module incompatible feature in accordance with one or more features of the present disclosure;

FIG. 5C is a cross-sectional view illustrating the removable module shown in FIG. 5B inserted into the base unit shown in FIG. 5A;

FIG. 6A illustrates a front view of an alternate embodiment of a base unit of a wiring device, the wiring device incorporating an alternate module rejection feature or module incompatible feature in accordance with one or more features of the present disclosure;

FIG. 6B illustrates a rear view (e.g., inner view) of the base unit and module rejection feature or module incompatible feature shown in FIG. 6A;

FIGS. 6C-6G illustrate various views of the module rejection feature or module incompatible feature shown in FIG. 6A; and

FIGS. 7A-7D illustrate various views of alternate embodiments of blades and openings that may be used in a wiring device including a base unit and a removable module.

It should be understood that the drawings are not necessarily to scale and that the disclosed embodiments or examples are sometimes illustrated diagrammatically and/or in partial views. In certain instances, details that are not necessary for an understanding of the disclosed methods and devices or which render other details difficult to perceive may have been omitted. It should be further understood that this disclosure is not limited to the particular embodiments or examples illustrated herein. In the drawings, like numbers refer to like elements throughout unless otherwise noted.

### DETAILED DESCRIPTION

Many modern appliances, devices, power equipment, lighting equipment, etc. rely on electrical power for operation. Electrical power is drawn from one or more electrical power sources. Access to such power sources is typically provided using various wiring devices that may be mounted to and/or in an electrical box (mounted in any suitable location) connected to an electrical power source. Non-limiting examples of such wiring devices include switches, outlets, universal serial bus (USB) ports (e.g., Type A, Type B, Type-C, Mini-A, Mini-B, Micro-A, Micro-B, or any other suitable form, etc.), circuit interrupters, lighting controls, fan speed controls, dimmers, occupancy sensors, heating ventilation air conditioning (HVAC) equipment/controllers, etc. Circuit interrupters may, for example, include ground fault circuit interrupters (GFCIs), arc fault circuit interrupters (AFCIs), resettable circuit interrupting device, immersion detection circuit interrupter (IDCIs), appliance leakage circuit breaker (ALCIs), latching interrupting devices, contactor, and overcurrent devices. Additionally, any suitable combinations of these devices can be integrated into a single wiring device (e.g., a combo device such as a combo GFCI/AFCI). Switches may include a load control device such as a toggle/paddle switch, a dimmer switch, etc. and can be used to control one or more loads, such as, a lighting load or a motor load, e.g., a fan. Outlets may include, e.g., electrical power outlets, data cable outlets, satellite/cable television outlets, security video outlets, adapters, splitters, transformers, etc. Some outlets provide alternating current (AC) to AC powered devices as well as to devices which first convert/transform the AC power to direct current (DC) or some other AC voltage/frequency via an external internal transformer.

Further, to provide an electrical connection to an appliance, equipment, device, etc., a plug coupled (e.g., permanently and/or temporarily) to the appliance using a wire or a flexible cord, is connected to an outlet disposed in a receptacle (e.g., a wiring device that includes one or more outlets that can receive a plug) that is typically fixed on a wall (e.g., a wall of a house, a building, etc.). For example, the wiring device may be secured within an electrical box within a building surface. Alternatively, or in addition, the plug may be connected to a piece of power equipment (e.g., a power generator). A typical plug includes a male connector and two or more protruding blades and/or pins that match openings/apertures and female contacts in an outlet of the receptacle. Typically, a plug will have a phase blade, a neutral blade, and a ground pin. Similarly, male connectors has corresponding female contacts and are typically fitted to an end of a flexible cord.

The receptacles connect electrical equipment to an AC power source or line voltages in residential houses, commercial buildings, factories, etc. A line voltage is supplied to buildings/residences (e.g., electric light and power), for example, 110 VAC, 115 VAC, 120 VAC, 125 VAC, 208 VAC, 220 VAC, 230 VAC, 240 VAC, single or multiphase. Such line voltage is typically made available to the end user standard plug/outlet configurations standardized by the National Electrical Manufacturers' Association (NEMA) configurations. One such standardized configuration is a NEMA 5-15 configuration which denotes a nominal 125 VAC/15 Amp outlet.

Some appliances, devices, equipment, etc. may require use of a low voltage. A low voltage refers to a voltage which is less than a certain threshold (50 Volts for example, AC or DC). This reduced voltage is typically used for communication, signaling, data/multimedia transmission, low voltage charging, and the like. For the purposes of the present application, the term low voltage also includes optical transmission (although no electrical voltage is actually transmitted by optical transmission).

£ Low voltage ports or cables denote any suitable type of communication or telecommunication low voltage ports or cables, such as, but not limited, to Universal Serial Bus (USB), Audio/Video/Multimedia, Digital Visual Interface (DVI), Ethernet/data (e.g., copper, RJ-45), High Definition Multimedia Interface (HDMI), IEEE 1394 (FireWire), Thunderbolt, Separate Video (S-Video), Video Graphics Array (VGA), coaxial (coax; F connector), headphone cords, telephone, or any suitable combination thereof. For the purposes of this application, low voltage ports can also include fiber optic ports (although no electrical voltage is actually transmitted by fiber optic ports).

Further, some appliances, devices, equipment, etc. may require different types of electrical plugs and receptacles, where such plugs/receptacles may vary in voltage, current rating, shape, size, connector types, etc. in accordance with various standard systems of plugs and receptacles around the world. As stated above, a typical receptacle includes one or more outlets, with each outlet having female electrical contacts that are configured to mate with male blades/prongs of a plug. There are different types of receptacles, such as, for example, decorator receptacles (e.g., having a rectangular front face with dimensions not typically exceeding 1.3 inch by 2.62 inch), duplex receptacles (e.g., having two outlet portions where each outlet portion has the shape of a circle with two equal circular segments removed, the circle having a radius not typically exceeding 1.327 inch), and/or any other types and/or configurations of receptacles.

Further, a typical wiring device is fitted with and/or covered by a wall plate. In addition to serving as a decorative piece, the wall plate covers wiring of an energized circuit of the wiring device, thereby protecting end users from contact with electrical wiring and/or other internal components of the wiring device and mitigating an electrical shock hazard.

Moreover, to protect users from electrical shock, receptacle openings are shaped to prevent finger contact with live electrical wiring and/or other electrical components of a wiring device. For example, electrical contacts are typically recessed behind receptacle openings, where blades of the plugs mate with the female electrical contacts and fit closely within the recessed receptacle openings to further reduce the risk of a user's finger accidentally contacting the live electrical contacts. In some cases, the blades may include insulation over at least a portion of their length. This further reduces exposure of energized metallic parts during plugging/unplugging of plugs into/out of the outlets. Additionally, some outlets include tamper resistant (TR) shutters or sliders (terms used interchangeably herein without the intent to limit or distinguish) to stop foreign objects from being inserted into energized contacts.

However, existing wiring devices are not able to provide interchangeable inserts or modules (terms used interchangeably herein without the intent to limit or distinguish) for positioning in such devices to allow for enhanced and/or different functionalities (e.g., interchangeable modules to enable easier replacement and/or changing of functionality).

As will be described herein, in some implementations, the present disclosure relates to electrical systems that include one or more wiring devices that include a base unit having one or more cavities configured to receive one or more removable modules to provide different, additional, and/or enhanced functionalities to the wiring device without altering and/or replacing internal wirings of the base unit of the wiring device. In use, the base unit of the wiring device may be electrically wired to a source of electrical power (e.g., AC power). In addition, and/or alternatively, in some implementations, the base unit may include one or more built-in functionalities such as, for example, an electrical outlet, an on/off switch, a network outlet, etc.

By way of a non-limiting example, the base unit of the wiring device may be configured as an on/off switch or an electrical receptacle/outlet (and/or any other type of electrical device). Such wiring device may be enhanced, upgraded, substituted, etc. with further functionalities, without removing/replacing the base unit wiring from its installation location (e.g., electrical box), and/or requiring services of a professional (e.g., an electrician), and/or an end-user (e.g., a homeowner) doing work with AC wiring. Some non-limiting examples of such enhancements, upgrades, substitutions, etc. may include: a dimming module (which, for example, may upgrade the on/off switch into a dimmer switch); a smart switch/dimmer module (which, for example, may upgrade the on/off switch to a network connected switch/dimmer capable of remote/smart control); an occupancy sensor-switch/occupancy sensor-dimmer module (which, may, for example, upgrade the on/off switch to a occupancy/vacancy sensor-switch/dimmer controlled device); a networked voice-control switch/dimmer module (which may, for example, upgrade the on/off switch to a voice/intelligent-assistant (Alexa™, Siri™, Google™, Bixby™, etc.) controlled switch/dimmer); as well as any other modules that may be configured to include one or more different, enhanced, advanced, and/or any other types of functionalities. As can be understood, the wiring devices may be configured as any other types of units and/or devices having one or more functionalities (e.g., network switches, light switches, etc.).

Moreover, in some implementations, the wiring devices may be configured to have a first functionality (e.g., an on/off switch, etc.) and may be configured to receive one or more modules having multiple second functionalities that may be same and/or different as the first functionality (e.g., on/off switch, dimmer switch, network switch, etc.). As can be understood, any single-and/or multiple-functionality modules may be added to any single-and/or multiple-functionality wiring devices. In some implementations, wiring devices may be configured as simple electrical “boxes” without being assigned any specific functionality and one or more modules may be added to provide a specific desired functionality.

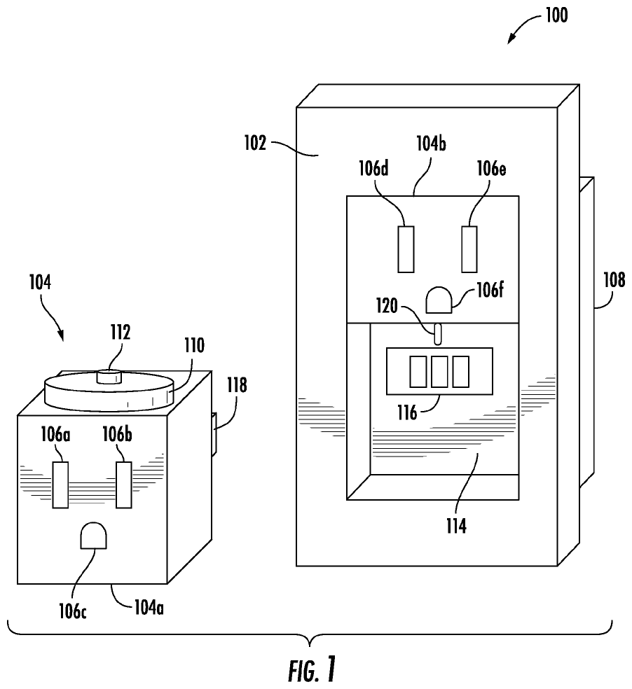

FIG. 1 illustrates a perspective view of an exemplary illustrative implementation of a wiring device 100. As shown, the wiring device 100 includes a base unit 102 and one or more removable inserts or modules 104 (terms used interchangeably herein without the intent to limit or distinguish). In addition, the wiring device 100 includes a coupling mechanism for securing the removable module 104 to the base unit 102. In use, while a particular coupling mechanism is shown and will be described, the coupling mechanism may be any suitable coupling mechanism for coupling the removable module 104 to the base unit 102 now known or hereafter developed. Thus, for purposes of the present disclosure, the wiring device 100 should not be limited to any specific coupling mechanism unless specifically claimed.

As generally shown in the exemplary implementation of FIG. 1, the base unit 102 may include a housing having a front portion, a rear wall, a top wall, a bottom wall, and two side walls. As such, the housing may, for example, be shaped as a box, a cube, a parallelopiped, etc. As can be understood, any desired shape of the housing is possible. In addition, as shown, the base unit 102 may also include an interior cavity 114 that may be partially enclosed by the walls of the housing. The front portion of the interior cavity 114 may be substantially open and may be configured to allow insertion (and subsequent securing) of the removable module 104 into the interior cavity 114 of the base unit 102.

In use, the base unit 102 of the wiring device 100 may be coupled to an electrical box (not shown in FIG. 1) that may, in turn, for example, be mounted to a building surface such as, for example, a wall, a ceiling, and/or any other desired location. In addition, the base unit 102 may be connected to an AC power source. In addition, as will be described in greater detail below, the base unit 102 may include one or more electrical contacts or terminals 116 (terms used interchangeably herein without the intent to limit or distinguish) positioned therein. In use, the electrical terminals 116 are sized and configured to receive one or more terminal contacts, terminals, blades, or contacts 118 (terms used interchangeably herein without the intent to limit or distinguish) extending from the removable module 104. The electrical terminals 116 of the base unit 102 being used to provide electrical connection, and thus electrical power, to the removable module 104 once the removable module 104 has been fully coupled to the base unit 102 of the wiring device 100 (e.g., the removable module 104 includes one or more terminal contacts 118 configured to interact and/or electrically couple to one or more electrical terminals 116 located in the base unit 102). Alternatively, in some embodiments, the terminals can be configured to provide data without providing power.

That is, with reference to exemplary implementation of the wiring device shown in FIG. 1, the base unit 102 of the wiring device 100 includes an interior cavity 114 used for positioning and securing of a removable module 104 (shown as a removable electrical outlet/receptacle 104a). The interior cavity 114 may be appropriately sized to accommodate such positioning/securing. The wiring device 100 may also include a second receptacle 104b. In some implementations, the second receptacle 104b may be configured to be integral (e.g., not removable) with the base unit 102 of the wiring device 100 and may be disposed adjacent to the interior cavity 114 (e.g., above the interior cavity 114 as shown in FIG. 1, although this is but one configuration and others are envisioned such as below or to the side). Alternatively, in some implementations, the second receptacle 104b may be removable similar to the first receptable 104a and may be received within the interior cavity 114, or a second cavity formed in the base unit 102 of the wiring device 100, which may be disposed adjacent to, or above, the interior cavity 114. The second receptacle 104b may be configured to provide electrical connection to one or more appliances, devices, equipment, etc. when such appliances, devices, equipment, etc. are plugged into the receptacles. Once secured inside the interior cavity 114, assuming the removable module 104 is another outlet or receptacle 104a, the removable module 104 may also be configured to provide electrical connection to one or more appliances, devices, equipment, etc. upon plugging such appliances, devices, equipment, etc. into the removable module 104. As can be understood, the second receptacle may be configured to provide any other functionality such as, for example, an on/off switch. As also can be understood, the removable module 104 may be configured to provide any other functionality.

As shown in the illustrated implementation, the second receptacle 104b may be configured to include electrical contact apertures or openings 106(d, e, f). The contact apertures or openings (terms used interchangeably herein without the intent to limit or distinguish) of the second receptacle 104b may be configured to provide access to female electrical contacts that may be configured to mate with male electrical blades or prongs of a plug of an appliance, device, equipment, etc. when a plug is plugged into the receptacle. Assuming removable module 104 is another outlet or receptacle 104a, as shown in FIG. 1, it may include electrical contact apertures 106(a, b, c) that may be used for connecting an electrical plug. Otherwise, the removable module 104 may provide any other desired functionality.

The wiring device 100 may also be partially covered by a wall plate (not shown) that may provide protection (as well as serve a decorative purpose) to the end user from electrical components of the wiring device 100. For simplicity and ease of illustration only, various internal components, such as, electrical wiring, connections to electrical power source, structural mounting components (e.g., mounting straps, screws, etc.), etc. are not shown in FIG. 1. Such electrical wiring and/or connections may be disposed in or proximate to a rear portion 108 of the wiring device 100 and may be connected to the outlet box (not shown in FIG. 1).

As stated above and as shown in FIG. 1, the removable module 104 may be removably secured within the interior cavity 114 of the base unit 102, where such removable securing allows adding, enhancing, upgrading, changing, etc. one or more functionalities of the wiring device 100. For example, instead of being another electrical outlet, the removable module 104 may be configured as a dimmer switch, thereby adding dimmer switch functionality to the wiring device 100. This results in the wiring device 100 having two functionalities: an electrical outlet (as provided by the second receptacle 104b) capable of receiving plugs of various electrical devices, appliances, equipment, etc. and a dimmer switch. In an alternate implementation, the removable module 104 may be configured as a network port (e.g., a USB/data port), thereby adding network functionality to the wiring device 100 allowing it to have electrical outlet functionality (again, as provided by the second receptacle 104b) and network functionality together. An alternative embodiment may include a USB charging port to charge a portable/mobile device such as a tablet or cellphone. Such a charging port may or may not include network connectivity. The ability to swap out removable module 104 in the wiring device 100 allows the end user to quickly add, enhance, upgrade, change, etc. one or more functionalities of the wiring device 100 without opening the wiring device 100 (e.g., rewiring the base unit 102 of the wiring device 100 to electrical power source) and accessing its internal components, thus, mitigating possibility of electrical shock.

As previously mentioned, to provide electrical connection to the removable module 104, the interior cavity 114 may include one or more electrical terminals 116, which are configured to mate with one or more terminal contacts 118 of the removable module 104. In use, and as illustrated, access to the electrical terminals 116 may be provided by a plurality of openings formed in the front facing surface of the interior cavity 114. By way of a non-limiting example, the terminal contacts 118 can be male blades and the electrical terminals 116 can be female contacts. The electrical terminals 116 can be electrically connected to electrical power source (not shown in FIG. 1) via electrical wiring.

Upon being inserted into the interior cavity 114, the removable module 104 may be secured within the interior cavity 114 using any suitable coupling mechanism. By way of a non-limiting example, as shown in FIG. 1, a latch 110 that may be pivotally mounted on a top surface of the removable module 104 using pivotal connection 112. The latch 110 may be configured to interact with a pin 120 disposed within the interior cavity 114 of the wiring device 100. The pin 120 may be configured to be mounted on the top surface of the interior cavity 114 and project in a downward direction from the top surface of the interior cavity 114. Upon insertion of the removable module 104 into the interior cavity 114, the latch 110 can be rotated about the pivotal connection 112 in a first direction (e.g., clockwise in FIG. 1) so that the latch 110 can engage the pin 120 and lock the removable module 104 inside the interior cavity 114. To remove the removable module 104 from the interior cavity 114, the latch 110 can be rotated in a second direction (e.g., counterclockwise), thereby releasing or disengaging from the pin 120 and unlocking (the removable module 104 from inside the interior cavity 114), allowing its removal. As can be understood, any other ways of securing/removing the removable module 104 in/from the interior cavity 114 are possible.

As stated above, once the coupling mechanism is released, the removable module 104 can be pulled away or removed from the interior cavity 114 of the base unit 102. While pulling or removing the removable module 104, the terminal contacts 118 of the removable module 104 become disengaged from the electrical terminals 116, allowing the removable module 104 to be completely removed from the interior cavity 114 of the base unit 102.

To secure the removable module 104 inside of the interior cavity 114 of the base unit 102, the removable module 104 is aligned with and inserted into the interior cavity 114. Thereafter, the coupling mechanism may be utilized to secure the removeable module 104 within the interior cavity 114 of the base unit 102. With the removable module 104 coupled to the base unit 102, the terminal contacts 118 of the removable module 104 pass through the plurality of openings formed in the front facing surface of the interior cavity 114 and engage, contact, interact with, etc. the electrical terminals 116 of the base unit 102 to provide electrical connection to the removable module 104.

Additional information on wiring devices including a cavity for receiving a removable module is contained in U.S. Patent Application No. 63/453,783, filed Mar. 22, 2023, entitled “Separable Components in Wiring Devices;” U.S. Patent Application No. 63/527,453, filed Jul. 18, 2023, entitled “Modular Wiring Devices, Systems and Methods;” and U.S. Patent Application No. 63/621,693, filed Jan. 17, 2024, entitled “Modular Wiring Devices, Systems and Methods.”

When removable modules are not positioned within the interior cavity 114 of the base unit 102, the electrical terminals associated with the openings (e.g., electrical terminals 116) may be accessed, exposed, or the like. As such, as will be described in greater detail herein, in accordance with one or more features of the present disclosure, the base unit includes a tamper-resistant (TR) mechanism configured to block, prevent, etc. access to the electrical terminals within the base unit when the removable module is not inserted or coupled to the base unit.

In addition, and/or alternatively, as will be described in greater detail herein, in accordance with one or more features of the present disclosure that may be used in combination with the TR mechanism or separately therefrom, the base unit and the removable modules may incorporate a module rejection feature or a module non-compatibility feature (terms used interchangeably herein without the intent to limit or distinguish). That is, as described herein, the wiring devices are configured to provide for modularity of modules, and thus functionality. However, in use, not all modules work with, or are functionally compatible with, all base units. That is, not all modules are electrically and/or functionally compatible with all base units (e.g., some modules will not work with certain base units due to electrical and/or functionality discrepancies). For example, a smart switch module may not work in a receptacle base unit if the receptacle base unit does not include a connection to a load to be controlled by the smart switch module. With a plurality of differently available modules and base units, the incompatible combinations of module/base unit need to be prevented. As such, in use, by incorporating a module rejection feature or mechanism (terms used interchangeably herein without the intent to limit or distinguish), a particular module can be allowed to or prevented from being received by a particular base unit. Thus, in use, the mechanism selectively allows or prevents a particular module to be received by a particular base unit.

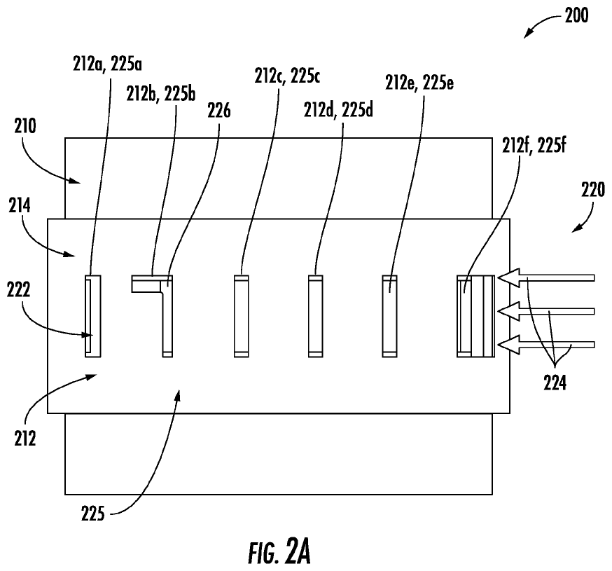

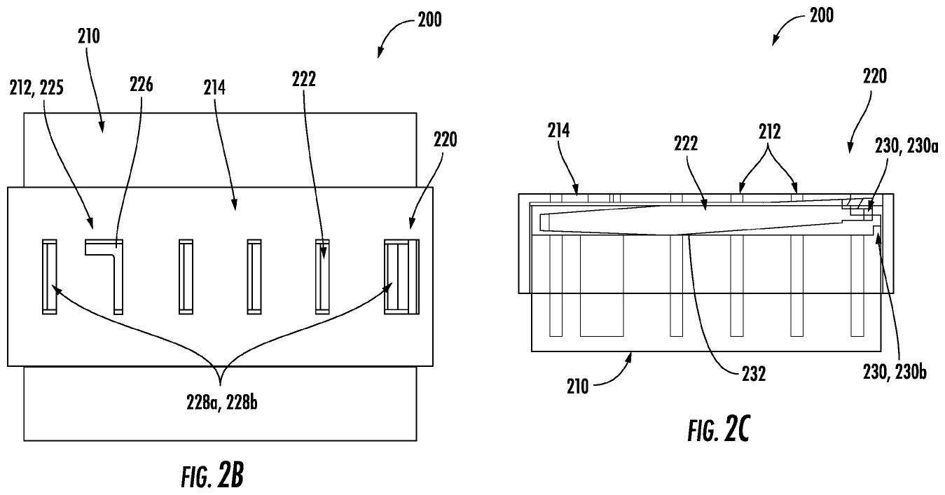

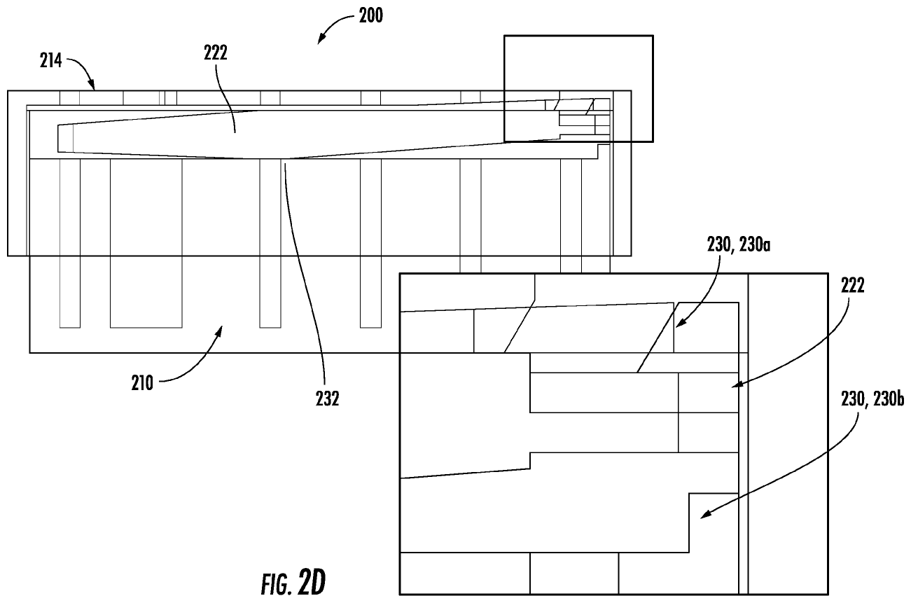

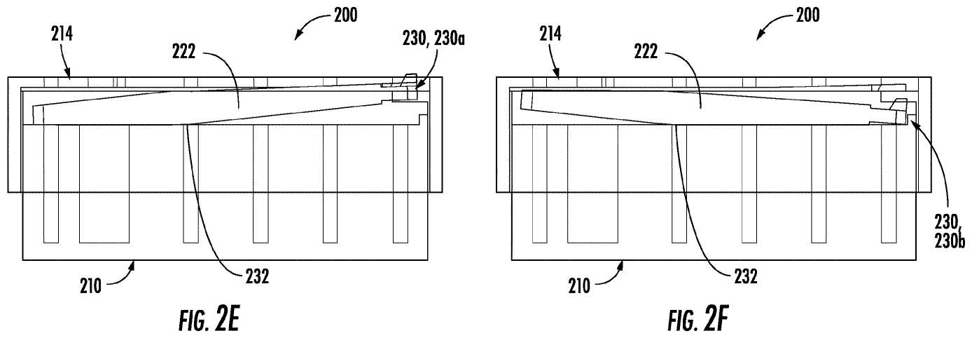

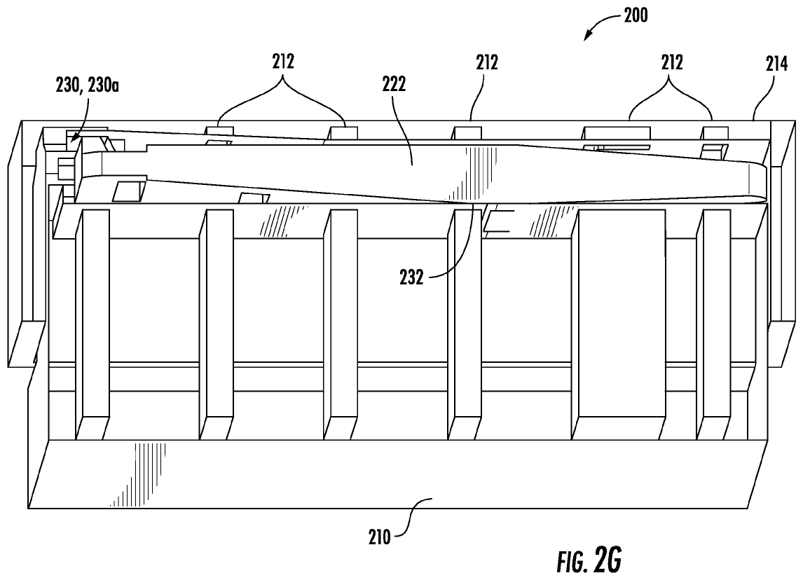

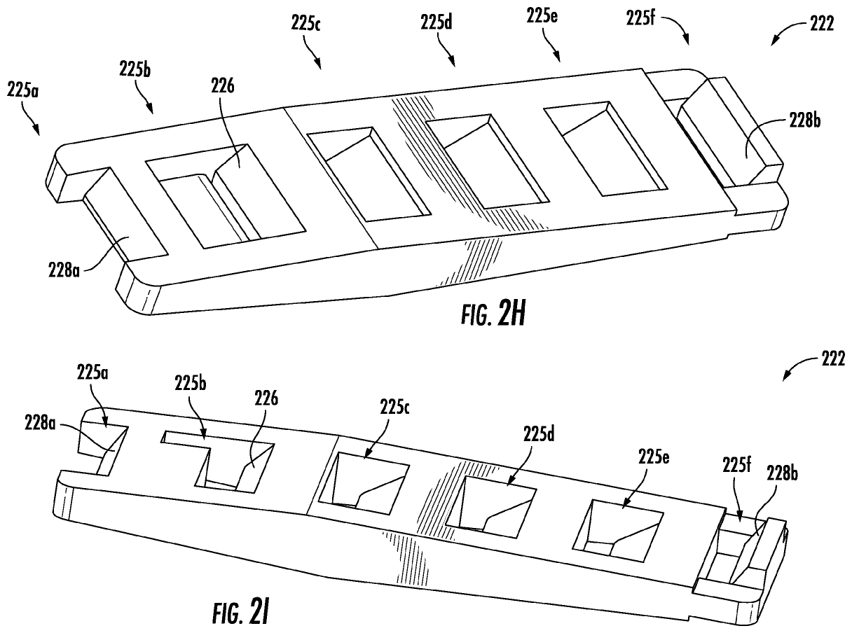

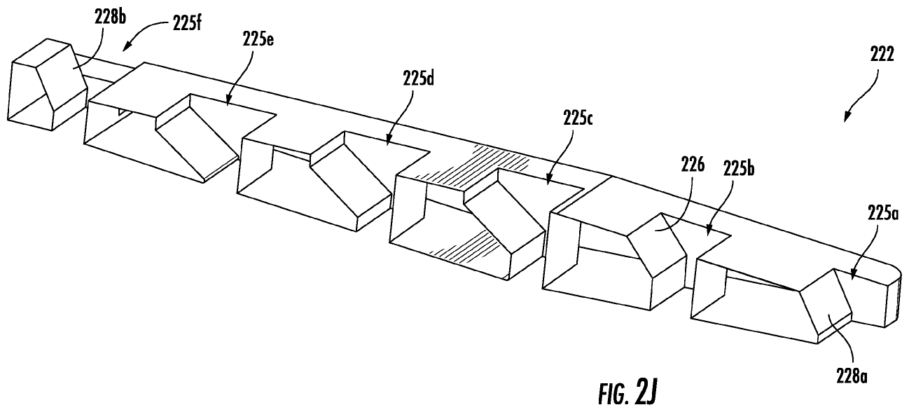

In accordance with one or more features of the present disclosure, with reference to FIGS. 2A-2G, the wiring device 200 may include a base unit 210. In some embodiments, the base unit 210 may be substantially similar to base unit 102 previously described herein. In accordance with one or more features of the present disclosure, the base unit 210 incorporates a tamper-resistant (TR) mechanism 220 to block access to the electrical terminals such as, for example, electrical terminals 116, positioned within the base unit 210 unless a sequence of events, operations, movements, etc. (terms used interchangeably herein without the intent to limit or distinguish) occurs to expose the electrical terminals. That is, with reference to the drawings and as will be readily appreciated by one of ordinary skill in the art, the base unit 210 includes a plurality of electrical terminals (e.g., electrical terminals 116) positioned within the housing of the base unit 210. In addition, the base unit 210 includes a plurality of openings 212 formed in a front facing surface 214 of the cavity (e.g., interior cavity 114) thereof to provide access to the plurality of electrical terminals positioned therein. In addition, the base unit 210 includes, or is operatively associated with a TR mechanism 220, which includes, or is operatively associated with, a slider 222 (an embodiment of which is shown in FIGS. 2H-2J). In use, the slider 222 is positioned between the plurality of openings 212 formed in the front facing surface 214 of the cavity and the plurality of electrical terminals positioned within the housing of the base unit 210. In addition, the slider 222 is moveable between a first or rest position, in which the slider 222 prevents access to the electrical terminals positioned within the housing of the base unit 210, and a second or opened position, in which a plurality of openings 225 (also referred to herein as slider openings) formed in the slider 222 align with the plurality of openings 212 formed in the front facing surface 214 to enable access to the electrical terminals positioned within the housing of the base unit 210. As such, electrical terminals such as blades or terminal contacts (e.g., terminal contacts 118) extending from a compatible removable module can pass through corresponding openings 212 formed in the front facing surface 214 of the cavity and the corresponding openings 225 formed in the slider 222 to enable the electrical terminals (e.g., blades or terminal contacts) to contact the electrical terminals positioned within the housing of the base unit 210.

In connection with base unit 210 that is configured to receive a removable module, the base unit 210 requires at least three electrical terminals to provide electrical connection (i.e., ground, phase, and neutral). To prevent inadvertent access to the electrical terminals, the base unit 210 includes a TR mechanism 220, which includes a slider 222 positioned between the front facing surface 214 of the base unit 210 and the electrical terminals positioned within the base unit 210. In use, in accordance with features of the present disclosure and as will be described in greater detail below, the slider 222 blocks or prevents access to the electrical terminals unless a sequence of operations occurs. If the sequence of operations occurs, the slider 222 is moved against the force of a biasing member 224 to enable the blades (e.g., terminal contacts 118) from the removable module such as, for example, receptacle module 104a, to pass through corresponding openings 212 formed in the front facing surface 214 of the cavity and the plurality of openings 225 formed in the slider 222 to enable the blades (e.g., terminal contacts 118) from the removable module to contact the electrical terminals positioned within the housing of the base unit 210. However, if the sequence of operations does not occur, for example, if an end user attempts to insert a foreign object into one of the openings, the slider 222 locks to prevent access to the electrical terminals.

That is, as will be described in greater detail below, the base unit 210 of the wiring device 200 may include, or be operatively associated with, a front facing surface 214 and a slider 222. In addition, the base unit 210 may include a biasing member 224 to bias the slider 222 to a first position, (as generally illustrated in FIG. 2A). In the first position, access to the electrical terminals positioned within the base unit 210 is prevented (e.g., as illustrated in FIG. 2A, the slider 222 is biased to the left, although this is but one configuration). In the first position (FIG. 2A), the slider 222 prevents objects from passing through the openings 225 formed in the slider 222 and into contact with the electrical terminals, which may be energized, positioned within the base unit 210. For example, in the first position (FIG. 2A), the openings 225 formed in the slider 222 are not aligned with the openings 212 formed in the front facing surface 214 of the cavity of the base unit 210. In use, the biasing member 224 may be any biasing member now known or hereafter developed such as, for example, one or more springs positioned between the slider 222 and the housing of the base unit 210. Note, while slider openings 225a-225f are referenced in FIG. 2A, the slider openings 225a-225f are not aligned with openings 212a-212f until the second position.

In use, the sequence of operations or method of action needed to move the slider 222 to a second or opened position, which enables access to the electrical terminals positioned within the base unit 210, utilizes one of the blades (e.g., terminal contacts 118) extending from the removable module such as, for example, the ground blade of the removable module, although this is but one configuration and other blades may be used. That is, for example, in use, during insertion of a removable module into a compatible base unit 210, the ground blade of the removable module contacts a surface (e.g., a first surface) such as, for example, an angled surface 226 (also referred to herein as a slider bearing surface) formed on the slider 222 aligned with the opening 212b corresponding to the ground opening. Thus arranged, the interaction between the ground blade of the removable module and the angled surface 226 on the slider 222 causes the slider 222 to move side-to-side by a certain distance relative to the front facing surface 214, which results in additional surfaces (e.g., angled surfaces 228a, 228b (e.g., second and third surfaces or slider bearing surfaces)) being exposed (FIG. 2B). That is, as illustrated in FIG. 2A, in the first position, the second and third angled surfaces 228a, 228b are hidden or non-accessible, it is not until an intermediate position (illustrated in FIG. 2B), which occurs after the first or ground blade contacts the first angled surface 226 to move the slider 222 an initial distance that the second and third angled surfaces 228a, 228b become exposed. Contact of the ground blade of the removable module with the first angled surface 226 on the slider 222 causes the slider 222 to move laterally (e.g., side-to-side) relative to the front facing surface 214, which results in additional surfaces (e.g., second and third angled surfaces 228a, 228b) being exposed (FIG. 2B). Thus, in some embodiments, the slider 222 moves laterally causing two additional angled surfaces 228a, 228b to be exposed so that further insertion of the removable module causes second and third blades (e.g., second and third terminal contacts of the module) to contact the second and third angled surfaces 228a, 228b that are now exposed. In turn, the interaction between the second and third blades (e.g., terminal contacts of the removable module) and the second and third angled surfaces 228a, 228b causes the slider 222 to move further relative to the front facing surface 214 thereby providing access to the electrical terminals positioned within the base unit 210 (e.g., interaction between the blades (e.g., terminal contacts of the removable module) and the surfaces on the slider 222 of the TR mechanism moves the slider 222 out of the way so that the plurality of openings 225 formed in the slider 222 align with the plurality of openings 212 formed in the front facing surface 214 thereby exposing all of the electrical terminals positioned within the base unit so that the blades (e.g., terminal contacts 118) from the removable module (e.g., receptacle module 104a) can engage the electrical terminals positioned within the housing of the base unit 210). In some embodiments, insertion of the ground blade into contact with the first angled surface 226 moves the slider 222 approximately 0.030 inches relative to the front facing surface 214.

As illustrated, the front facing surface 214 may include a plurality of openings 212 and the slider 222 may include a plurality of openings 225. For example, as illustrated, each of the front facing surface 214 and the slider 222 may include six openings (e.g., openings 212a-212f and opening 225a-225f), although this is but one configuration and the front facing surface and/or slider may include more or less openings. In the illustrated exemplary embodiment, the ground opening, and thus the first angled surface 226 formed on the slider 222, may correspond with the second opening 212b, 225b from the left, although this is but one configuration and other openings may correspond to the ground opening. In addition, and/or alternatively, the openings corresponding to the second and third blades, and thus the second and third angled surfaces 228a, 228b formed on the slider 222, may correspond with the openings corresponding with the extreme ends of the slider (e.g., openings one and six 212a, 225a, 212f, 225f in the illustrated exemplary embodiment, although this is but one configuration and the angled surfaces may be formed along other openings). In addition, while the exemplary embodiment has been described as requiring an initial angled surface followed by second and third angled surfaces, this is but one configuration and more or less angled surfaced surfaces may be used.

In use, the second and third angled surfaces 228a, 228b formed on the slider 222 are configured with a specific offset corresponding to the second and third blades of the removable module with which they are intended to contact. Thus arranged, the subsequently exposed angled surfaces 228a, 228b, which were initially hidden from view (e.g., non-accessible) via the front facing surface 214 in the first position, are configured such as, for example angled, and are configured to interact with the mating blades so that when a compatible removable module is inserted, the blades of the removable module interact initially with the first angled surface 226 to expose the additional angled surfaces 228a, 228b, and then with the second and third angled surfaces 228a, 228b to move the slider 222 against the force of the biasing member 224 to enable access to the electrical terminals (e.g., to enable the blades of the removable module to pass through the openings 212 in the front facing surface 214 and the openings 225 formed in the slider 222 to allow the blades of the removable module to mate with the electrical terminals positioned within the base unit 210). In some embodiments, as illustrated in FIG. 2C, the first and second ends of the slider 222 are vertically offset relative to each other.

Alternatively, as will be described in greater detail below, if the offset is incorrect (e.g., if the blades of the removable module are not properly configured to mate with the angled surfaces of the slider indicating, for example, an incompatible removable module, or if an end user attempts to insert a foreign object into one of the openings), the slider 222 will move (e.g., rock, pivot, tilt, move front-to-back, or the like) causing the slider 222 to contact one or more locking surfaces or ledges 230 within the base unit 210 thus fixing, locking, etc. the slider 222 to prevent it from moving.

That is, as previously mentioned, the slider 222 may be biased to the first position (FIG. 2A) via one or more biasing members 224 such as, for example, one or more springs. In addition, as previously mentioned, in use, one of the openings 212 formed in the front facing surface 214 may be aligned with one or more angled surfaces 226 formed on the slider 222 to enable one of the blades from the removable module to contact, interact with, or the like, the angled surface 226 formed on the slider 222. As illustrated, the second opening 212b formed in the front facing surface 214 may be arranged and configured to interact with the ground blade of the removable module. For example, in use, the ground blade of the removable module may be provided with a longer length so that the ground blade contacts the exposed angled surface 226 of the slider 222 prior to any other blades, although this is but one configuration and other configurations are envisioned.

In use, contact of the ground blade with the exposed angled surface 226 of the slider 222 causes the slider 222 to move laterally (i.e., moves to the right as illustrated in the figures). This movement causes second and third surfaces 228a, 228b formed on the slider 222 to become exposed (FIG. 2B). Thereafter subsequent contact with second and third blades extending from the removable module with the subsequently exposed second and third surfaces 228a, 228b on the slider 222 cause the slider 222 to move laterally an additional distance to the second position so that the plurality of openings 225 formed in the slider 222 are aligned with the plurality of openings 212 formed on the front facing surface 214 of the base unit 210 so that the blades from the removable module can pass into contact with the electrical terminals positioned within the base unit 210. In some embodiments, the second and third blades of the removable module contact the second and third surfaces 228a, 228b of the slider 222 simultaneously, or substantially simultaneously (e.g., within a close proximity of time) to prevent the slider 222 from rocking or rotating as will be described in greater detail below.

With reference to FIGS. 2A and 2B, in the illustrated exemplary embodiment, the corresponding ground opening 212b formed in the front facing surface 214 may be L-shaped, although other configurations are envisioned. In addition, and/or alternatively, in the illustrated exemplary embodiment, the second and third subsequently exposed surfaces 228a, 228b may be provided on the first and sixth openings 212a, 212f, 225a, 225f (e.g., extreme ends of the slider 222), although other configurations are envisioned.

However, with reference to FIGS. 2C, 2D, 2E, and 2F, the base unit 210 includes one or more lock surfaces or ledges 230 formed therein. In the illustrated exemplary embodiment, the base unit 210 may include first and second locking surfaces or ledges 230a, 230b formed therein, the first lock surface or ledge 230a may be positioned along the inner surface of the front facing surface 214 to mate with a first or top surface or edge of the slider 222, the second lock surface or ledge 230b may be positioned along the inner surface of the base unit 210 to mate with a second or bottom surface or edge of the slider 222, although this is but one configuration and other configurations are envisioned.

In use, when a compatible removable module is being inserted into the base unit 210, the proper sequence of operations is preformed causing the slider 222 to move from the first position to the second position relative to the front facing surface 214 and the base unit 210 so that the slider 222 does not interact with, contact, etc. the first or second locking surfaces or ledges 230 (e.g., as schematically illustrated in FIG. 2D, the blades extending from a compatible module have contact the slider 222 in the proper sequence, as a result, the slider 222 remains at the proper vertical offset and the slider 222 remains balance so that it moves passed the locking surfaces or ledges 230).

However, with reference to FIGS. 2E and 2F, if the proper sequence of operations is not followed such as may occur if an incompatible module was being inserted into the base unit 210 or if a foreign object was being inserted by the end user, the slider 222 moves (e.g., rocks, rotates, etc.) so that the slider 222 contacts one of the first and second locking surfaces or ledges 230a, 230b. As will be appreciated by one of ordinary skill in the art, the slider 222 will contact either the first or second locking surface or ledge 230a, 230b depending on which opening 212 the object is initially inserted (with respect to the fulcrum 232 (FIG. 2G)). For example, insertion of a foreign object into one of the openings on the left-hand side causes the slider 222 to rock upwards along the right-hand side into contact with the first locking surface or ledge 230a (FIG. 2E, and upwards along the left-hand side in FIG. 2G). Insertion of a foreign object into one of the openings on the right-hand side causes the slider 222 to rock downwards along the right-hand side into contact with the second locking surface or ledge 230b (FIG. 2F).

Thus arranged, contact between the slider 222 with one of the first and second locking surfaces or ledges 230a, 230b prevents the slider 222 from moving to the second position thereby preventing access to the electrical terminals positioned within the base unit 210 (e.g., slider locks into the first position such that the plurality of openings 225 formed in the slider 222 are not aligned with the plurality of openings 212 formed in the front facing surface 214).

Thus arranged, in accordance with features of the present disclosure, the TR mechanism 220 prevents access to the electrical terminals positioned within the base unit 210 unless a compatible module is being inserted into the base unit 210. That is, as described herein, after initial insertion of the ground blade into the ground opening 212b, the TR mechanism 220 may require two blades (e.g., second and third blades) of the same length to be substantially simultaneously inserted into the second and third openings (illustrated as first and sixth openings 212a, 212f formed in the front facing surface 214) in order for the slider 222 to move to the second position. If only one element or if incompatible elements are being inserted, the slider 222 will move (e.g., rock, rotate, or the like) into contact with a locking surface or ledge 230 to prevent the slider 222 from moving to the second position.

As described herein, in use, in the illustrated exemplary embodiment, the proper sequence of operations requires insertion of the first blade (e.g., ground blade) into the corresponding ground opening to move the slider laterally a certain distance, which causes second and third surfaces on the slider to be exposed. Thereafter, subsequent substantially simultaneous contact of the second and third surfaces with second and third blades cause the slider to move laterally an additional distance to the second position.

As such, in accordance with one or more features of the present disclosure, in use, the slider 222 is configured to be moved from a first position to a second position upon insertion of a removable module such as, for example, removable module 104, only if the plurality of electrical terminals (e.g., terminal contacts 118) are arranged and configured to fit through, and align with, the corresponding plurality of openings 212 formed in the front facing surface 214 of the base unit 210 and only upon the occurrence of at least two of the plurality of electrical terminals (e.g., terminal contacts 118) making physical contact with two of the corresponding prescribed contact locations (e.g., bearing or angled surfaces formed on the slider 222) of the plurality of prescribed contact locations in accordance with a prescribed contact sequence.

In some embodiments, as previously described herein, the plurality of prescribed contact locations and the prescribed contact sequence are, defined by the arrangement and configuration of the plurality of openings 212 formed in the front facing surface 214 (e.g., base unit openings), the plurality of electrical terminals (e.g., electrical terminals 116) positioned in the base unit 210, the plurality of openings 225 formed in the slider 222 (e.g., plurality of slider openings), and/or the plurality of bearing or angled surfaces 226, 228a, 228b formed on the slider 222 (e.g., the plurality of slider contact surfaces). In use, at least one of the plurality of prescribed contact surfaces may be configured to interact with a corresponding first electrical terminal of the plurality of electrical terminals such that the slider 222 is urged by such interaction to move from the first position to the second position when at least one other prescribed contact surface of the plurality of contact surfaces interacts with a corresponding second electrical terminal of the plurality of electrical terminals, wherein the first and second electrical terminals interact with corresponding prescribed contact surfaces in accordance with the prescribed contact sequence.

In some embodiments, the prescribed contact sequence includes the first electrical terminal of the removable module interacting with the at least one of the plurality of prescribed contact surfaces on the slider to move the slider relative to the front facing surface by a predetermined distance. Movement of the slider by the predetermined distance causing the at least one other prescribed contact surface to become exposed so that the second electrical terminal of the removable module of the plurality of electrical terminals contacts the at least one other prescribed contact surface to move the slider to the second position.

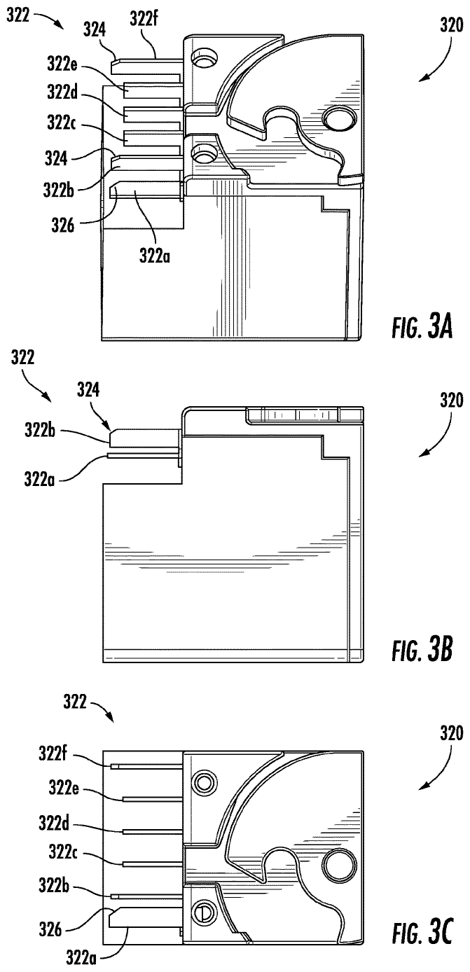

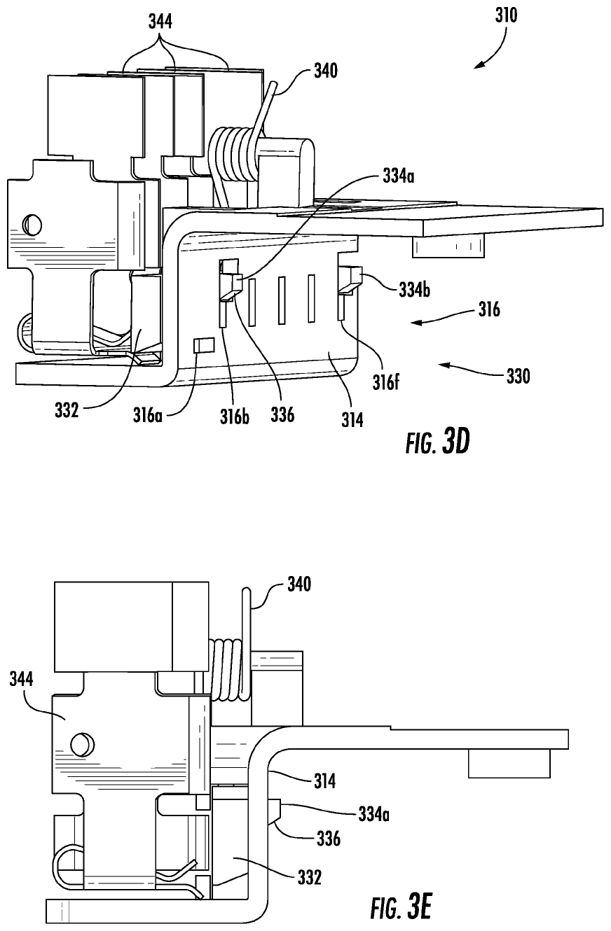

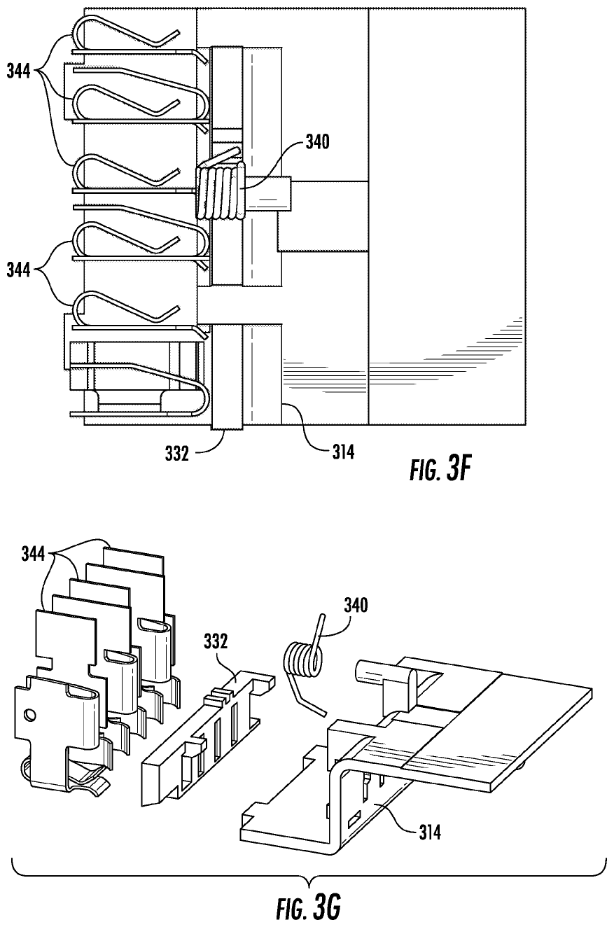

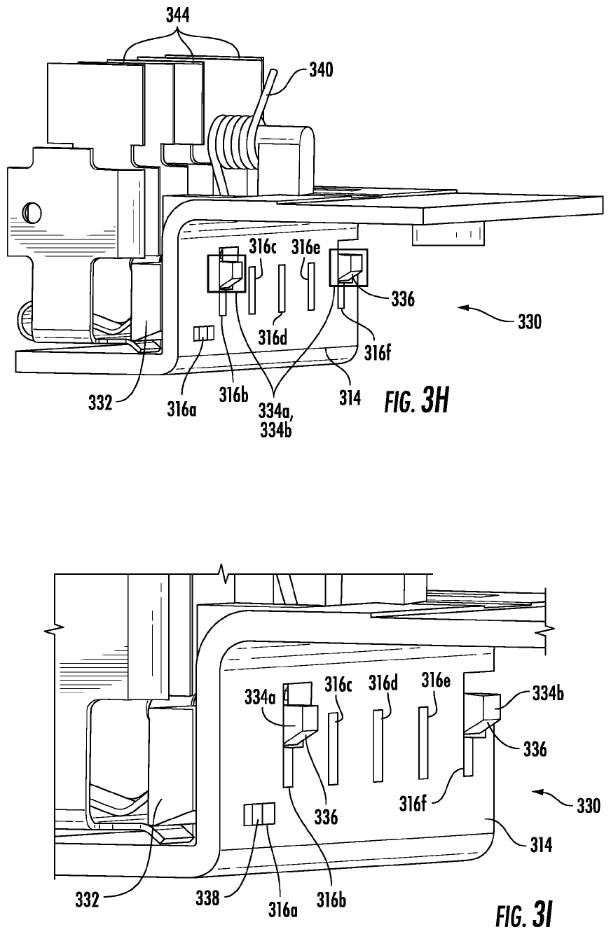

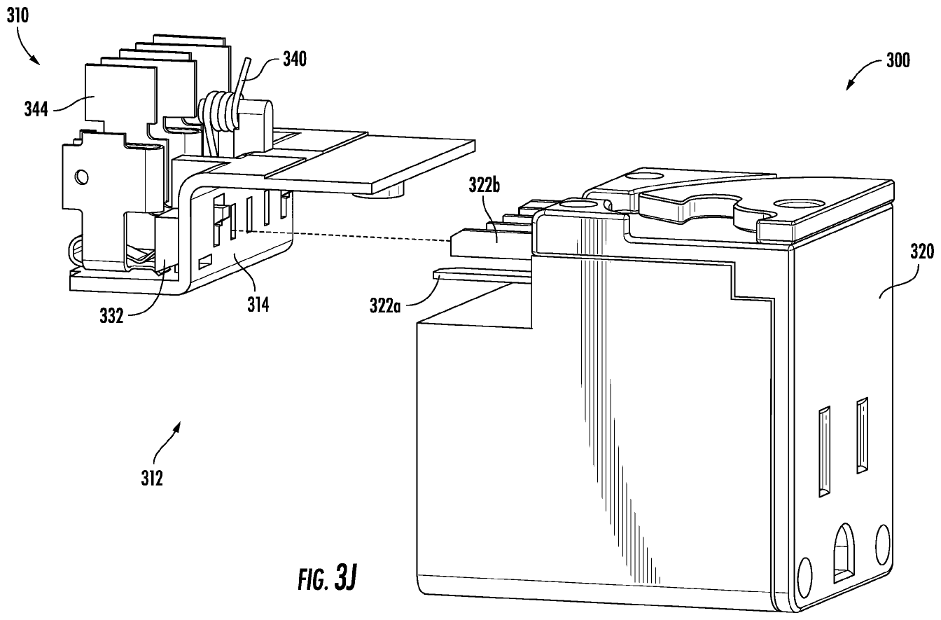

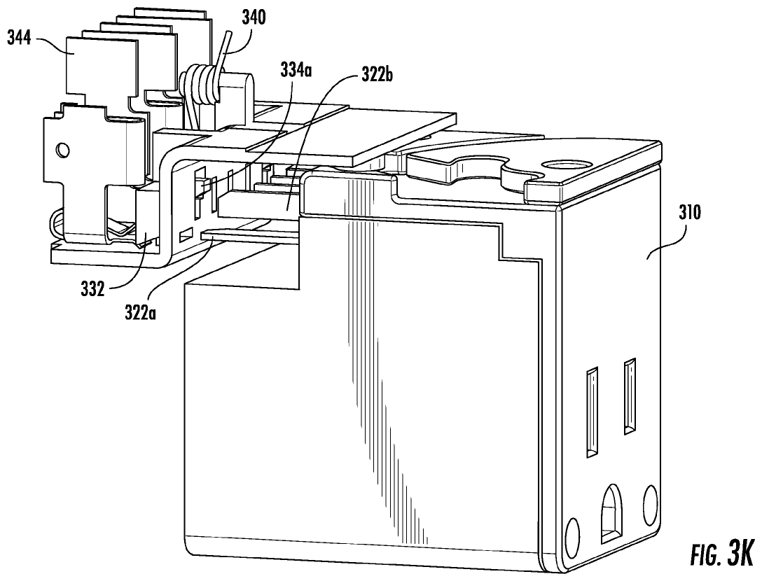

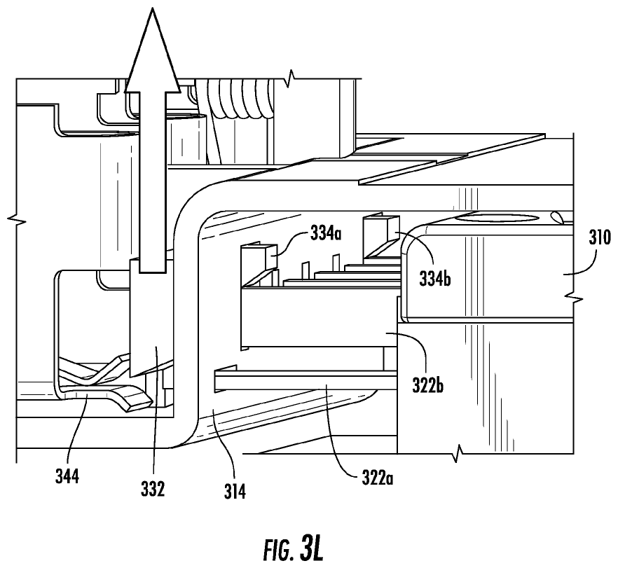

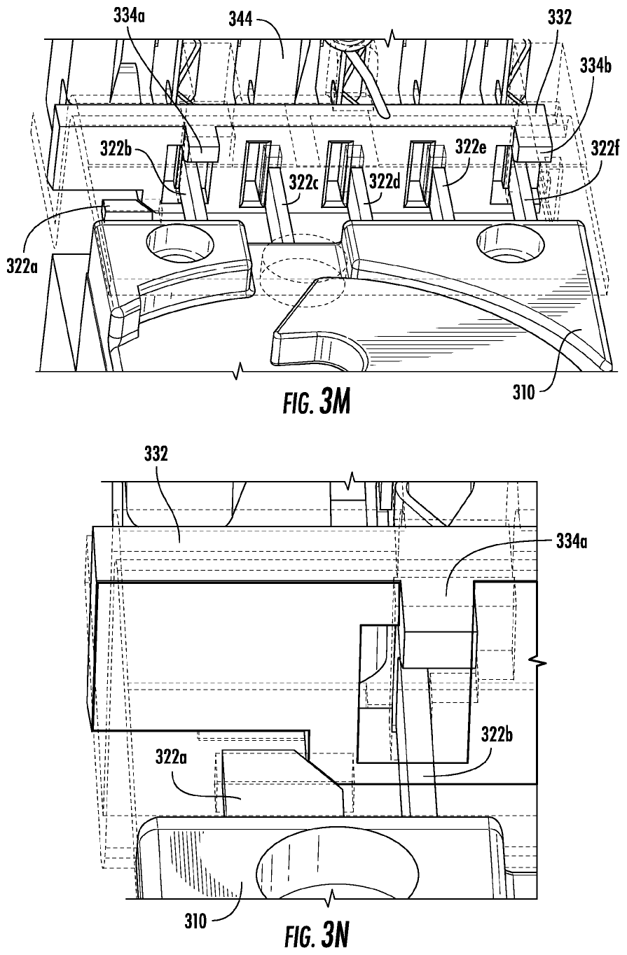

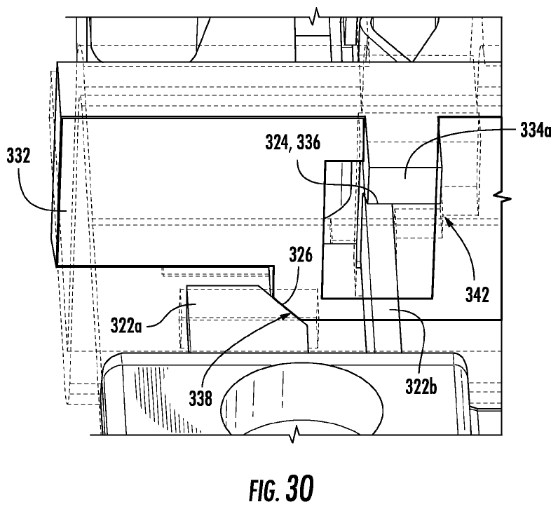

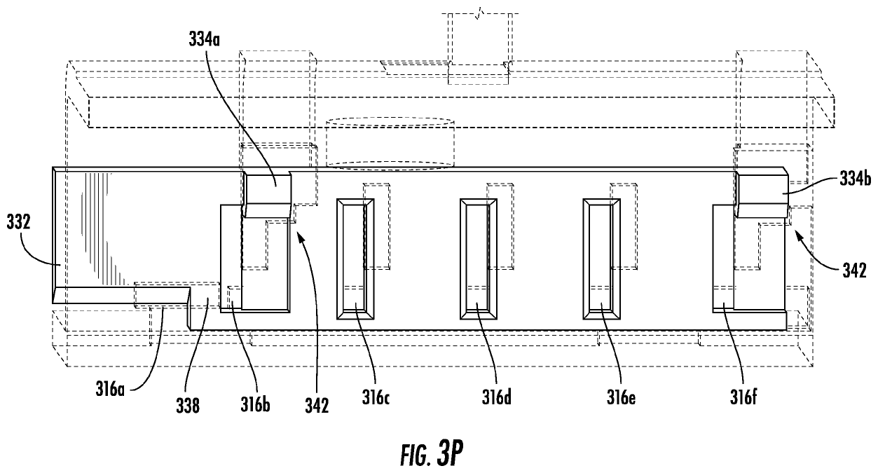

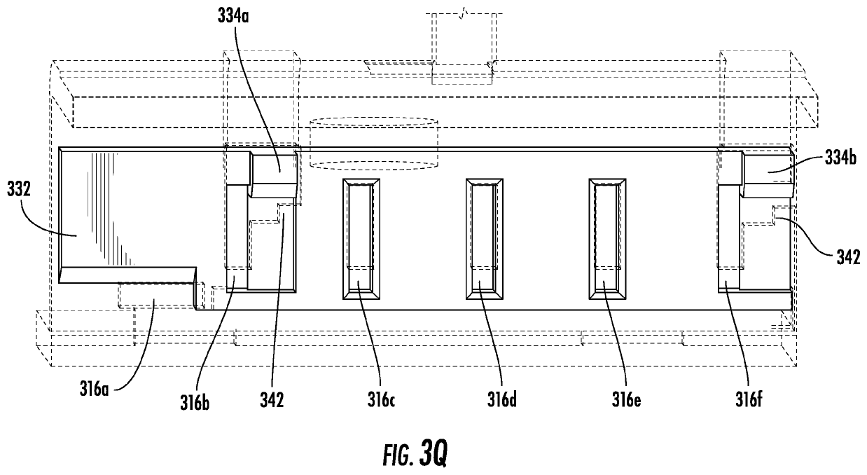

While a particular TR mechanism has been described and shown in connection with FIGS. 2A-2F, alternate TR mechanism are envisioned. For example, with reference to FIGS. 3A-3Q, a dual translation TR mechanism 330 may be used (e.g., a TR mechanism that utilizes movement in the vertical and horizontal direction to move the slider or shutter (terms used interchangeably herein without the intent to limit or distinguish) from a first position to a second or opened position). That is, as illustrated and as previously described, a wiring device 300 (FIG. 3J) may include a base unit 310 including an interior cavity 312 for receiving a removable module 320. The removable module 320 may include a plurality of electrical terminals, terminal contacts, or blades 322 (terms used interchangeably herein without the intent to limit or distinguish). As illustrated, the removable module 320 may include six blades 322a-322f extending therefrom, although this is but one configuration.

In the illustrated exemplary embodiment, one of the blades 322a may be orientated horizontally as compared to one or more of the remaining blades 322b-322f (e.g., horizontally extending blade 322a may be angled at a ninety-degree angle relative to the other blades 322b-322f, although this is but one configuration and other angles may be used). In addition, as illustrated, the removable module 320 may include first and second vertically extending blades (illustrated as 322b and 322f, although other configurations are envisioned) that are arranged and configured with a longer overall length as compared to the other vertically extending blades 322c, 322d, 322e so that, in use, the first and second vertically extending blades 322b, 322f contact, interact with, etc. a slider 332 of the TR mechanism 330 before the other vertically extending blades 322c, 322d, 322e.

Thus arranged, in use, insertion of a compatible removable module 320 causes the first and second vertically extending blades 322b, 322f to contact first and second surfaces or protrusions 334a, 334b formed on the slider 332, although this is but one configuration and the system may include more or less longer blades and more or less surfaces or protrusions. As illustrated, in some embodiments, the first and second surfaces or protrusions 334a, 334b extend through first and second openings 316 formed in a front facing surface 314 of the base unit 310. That is, as illustrated in the exemplary embodiment, the front facing surface 314 of the base unit 310 includes a plurality of openings 316 corresponding to the electrical terminals 344 positioned within the base unit 310 and the plurality of blades 322 extending from a compatible removable module 320. The first and second surfaces or protrusions 334a, 334b may extend through openings 316b, 316f corresponding to first and second blades 322b, 322f, although this is but one configuration and the blades and protrusions may be provided in other areas. As illustrated, the first and second surfaces or protrusion 334a, 334b may include a ramped or angled surface 336 formed thereon for contacting, interacting with, etc. a corresponding ramped or angled surface 324 formed on the first and second vertically extending blades 322b, 322f. In addition, as illustrated, the horizontally extending blade 322a may include a ramped or angled surface 326 formed thereon for contacting, interacting with, etc. a corresponding ramped or angled surface 338 formed on the slider 332 along the portion corresponding with the horizontally extending opening 316a.

With reference to FIGS. 3J-3Q, an exemplary sequence of actions or movements will now be described to demonstrate how introduction of a removable module 320 into the interior cavity 312 of a base unit 310 causes the slider 332 of the TR mechanism 330 to move from the first position to the intermediate position and finally into the second or opened position so that the blades 322 extending from the removeable module 320 can be received within the electrical terminals 344 positioned within the base unit 310.

With reference to FIGS. 3J and 3K, insertion of a compatible removable module 320 into the interior cavity 312 of the base unit 310 causes the first and second longer extending vertical blades 322b, 322f to approach and contact the slider 332 moving the slider 332 vertically relative to the front facing surface 314. For example, as previously described, the first and second longer extending vertical blades 322b, 322f contact the first and second surfaces or protrusions 334a, 334b associated with the slider 332. Vertical movement of the slider 332 results in the surfaces or protrusions 334a, 334b moving out of contact with lock or abutting surfaces or edges 342 (FIGS. 3P and 3Q) formed on the front facing surface 314.

Thereafter, the horizontally extending blade 322a approaches and contacts the slider 332 moving the slider 332 horizontally to the second or opened position thereby enabling the blades 322 to be inserted through the openings 316 formed in the front facing surface 314. That is, horizontal movement of the slider 332 causes the slider 332 to move past the lock or abutting surfaces or edges 342 formed on the front facing surface 314. Thus arranged, the openings 316 formed in the front facing surface 314 align with the openings formed in the slider 332 and the electrical terminals 344. As such, all of the blades 322 extending from compatible removable module may be inserted into contact with the electrical terminals 344 positioned within the base unit 310. That is, in the illustrated example, the first and second vertically extending blades 322b, 322f contact the corresponding ramped or angled surfaces 336 formed on the first and second surfaces or protrusions 334a, 334b of the slider 332. Next, the horizontal extending blade 322a contacts the corresponding ramped surfaces or angled surface 338 formed on the slider 332. In turn, this results in the slider 332 moving to the second or opened position so that the blades 322 on the removeable module 320 can be inserted into contact, engagement, etc., with the terminals 344 positioned within the base unit 310.

With reference to FIGS. 3L-3O, interaction of the ramped or angled surfaces 336 formed on the first and second blades 322b, 322f of the removeable module 320 with the first and second surfaces or protrusions 334a, 334b formed on the slider 332 causes the slider 332 to move vertically from the first position to an intermediate position. Thereafter, with reference to FIGS. 3P and 3Q, the ramped surface 326 formed on the horizontally extending blade 322a contacts, interacts with, etc. the corresponding ramped surface or angled surface 338 formed on the slider 332 along the portion corresponding with the horizontally extending opening 316a, which causes the slider 332 to move horizontally from the intermediate position to the second or opened positioned (e.g., ramped or angled surface 326 on the horizontally extending blade 322a translates the slider 332 along its longitudinal axis (e.g., to the right in FIGS. 3P and 3Q) to the second or opened position against the bias of a biasing member 340. As illustrated, and as previously mentioned, the biasing member 340 may be any suitable biasing member now known or hereafter developed to bias the slider 332 to the first position. As illustrated, in some embodiments, the biasing member 340 may be in the form of a spring. FIG. 3P illustrates the first position of the slider 332 prior to the first and second blades 322b, 322f contacting the surfaces or protrusions 334a, 334b on the slider 332. FIG. 3Q illustrates the position of the slider 332 in the second or opened position, after the horizontal blade 322a contacts the slider 332 to move the slider 332 horizontally.

Thus, in use, contact of the first and second blades 322b, 322f with the first and second surfaces or protrusions 334a, 334b on the slider 332 moves the slider 332 vertically relative to the front facing surface 314 of the base unit 310 so that the surfaces or protrusions 334a, 334b clear lock or abutting surfaces or edges 342 associated with the front facing surface 314 of the base unit 310. Thereafter, interaction of the horizontally extending blades 322a enables the slider 332 to move horizontally relative to the front facing surface 314 of the base unit 310 so that the openings in the slider 332 are now aligned with the openings 316 in the front facing surface 314 and the electrical terminals 344 positioned within the base unit 310 so that the blades 322 can be inserted into contact with the electrical terminals 344.

Thus arranged, an alternate exemplary embodiment of a TR mechanism 330 is provided which utilizes dual translation (e.g., vertical and horizontal translation) to move the slider 332 from the first position to the second or opened position. As such, in accordance with features of the present disclosure, the TR mechanism 330 prevents access to the electrical terminals 344 positioned within the base unit 310 unless a compatible removeable module 320 is being inserted into the interior cavity 312 of the base unit 310.

As such, in accordance with one or more features of the present disclosure, in some embodiments, the slider is configured to be moved from the first position to the second position only in response to a predetermined sequence wherein the predetermined sequence includes each of the plurality of electrical terminals of the removable module aligning with a respective opening formed in the front facing surface of the base unit (e.g., also referred to herein as a wiring device opening). In use, in some embodiments, a first electrical terminal of the plurality of electrical terminals of the removable module exerts a first force on a first bearing surface of a plurality of bearing surfaces. Thereafter, a second electrical terminal of the plurality of electrical terminals of the removable module exerts a second force on a second bearing surface of the plurality of bearing surfaces, the first and second forces are exerted simultaneously to cause the slider to move from the first position to the second position.

In some embodiments, the sequence further includes the slider moving from the first position to an intermediate position in response to a third electrical terminal of the plurality of electrical terminals of the removable module exerting a third force on a third bearing surface of the plurality of bearing surfaces.

In some embodiments, the sequence may further include the slider moving from the intermediate position to the second position in response to a fourth electrical terminal of the plurality of electrical terminals of the removable module exerting a fourth force on a fourth bearing surface of the plurality of bearing surfaces.

In some embodiments, movement between the first position and the intermediate position occurs in a first direction and the movement between the intermediate position to the second position occurs in a second direction, wherein the first and second directions are parallel or perpendicular to each other.

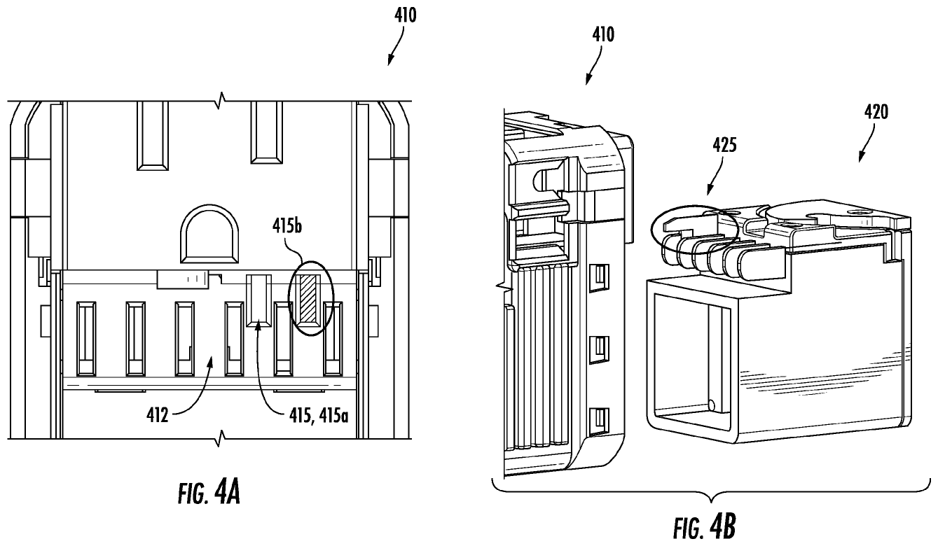

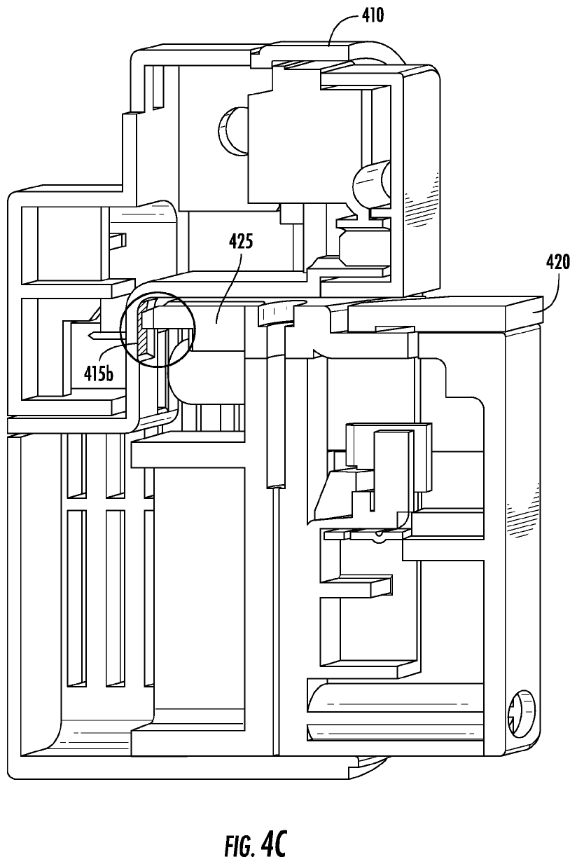

As previously mentioned, with reference to FIGS. 4A-6G, in accordance with one or more features of the present disclosure that may be used in combination with the previously described TR mechanisms or separately therefrom, the base unit and the removable modules may incorporate a module rejection feature. That is, in use, as previously mentioned, the wiring devices are configured to provide for modularity of modules, and thus functionality. However, in use, not all modules work with, or are compatible with, all base units (e.g., some modules are not compatible with certain base units and thus will not work with certain base units due to functionality discrepancies). As such, in accordance with one or more features of the present disclosure, by incorporating a module rejection feature, a particular module can be allowed to or prevented from being received by a particular base unit. Thus, in use, the mechanism selectively allows or prevents a particular module to be received by a particular base unit.

In some embodiments, the module rejection feature prevents modules which are not compatible with particular base units from being inserted therein (e.g., the module rejection feature prevents a module from being fully installed or inserted within the interior cavity of a base unit with the blades or terminal contacts of the module received by the corresponding electrical terminals positioned within the base unit). In some embodiments, the module includes a mechanism, a feature, or the like that prevents or interferes with the base unit to prevent the module from being inserted into the base unit (e.g., mechanism may rely on an interference between a feature on the module and a feature on the base unit).

For example, in some embodiments, with reference to FIGS. 4A-4C, the removeable module 420 may include a projection, an interrupter, or the like 425. In use, compatible base units 410 may include a corresponding opening 415 to receive the projection or interrupter 425. Alternatively, base units 410 which are incompatible with the removeable module 420 may omit the opening or the opening may be blocked. Thus arranged, in use, compatible removeable modules 420 can be inserted into the interior cavity 412 of the base unit 410 with the projection or interrupter 425 received within, inserted into, etc. the opening 415 formed in the base unit 410. However, incompatible modules cannot be inserted as the projection or interrupter 425 prevents the module from being fully inserted into the interior cavity 412 of the base unit 410 (e.g., projection or interrupter 425 on an incompatible removeable module 420 contacts a surface, a closed up hole, etc. (schematically illustrated as 415b in FIG. 4A) on the base unit 410 thereby preventing the removeable module 420 from being fully inserted). This interaction prevents the incompatible removeable module 420 from being fully installed into the cavity 412 of the base unit 410.

That is as illustrated in FIG. 4A, the base unit 410, which may be provided in the form of a receptable base unit, may include a first opening 415a that is available and a second opening 415b that is unavailable or closed. With reference to FIG. 4B, a compatible removeable module 420 may include a corresponding projection or interrupter 425 that is arranged and configured to be received within the first opening 415a of a compatible base unit 410 (e.g., the interrupter feature on the removeable module 420 can be received within the first opening 415a formed in the base unit 410). However, if an incompatible module was being inserted, the incompatible module would incorporate a projection or interrupter that was positioned such that it was not located to align with the first opening 415a. For example, an incompatible module may include a projection or interrupter 425 configured to be received within the second opening 415b. However, since the base unit 410 is not compatible with the module, the second opening 415b in the base unit 410 is closed or non-existent and thus the incompatible module cannot be inserted into the base unit 410 (e.g., the projection or interrupter 425 on the incompatible module contacts the closed or non-existent second opening 415b formed in the base unit 410 preventing the incompatible module from being fully inserted into the interior cavity 412 of the base unit 410). FIG. 4C illustrates the interaction between the base unit 410 and interrupter 425 when trying to install a removeable module 420 in an incompatible base unit 410.

In use, the projection or interrupter 425 may be located anywhere on the removeable module 420. In addition, and/or alternatively, the projection or interrupter 425 may be manufactured from any suitable material such as, for example, a plastic.

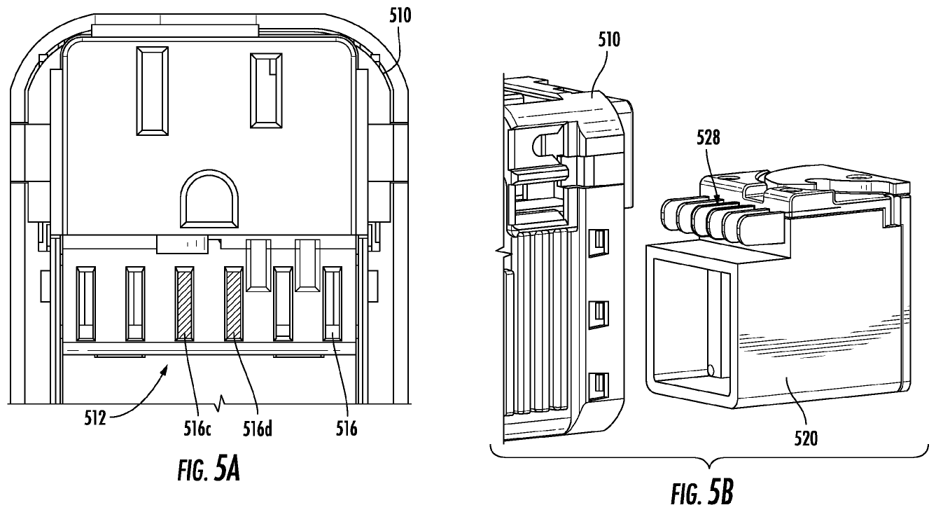

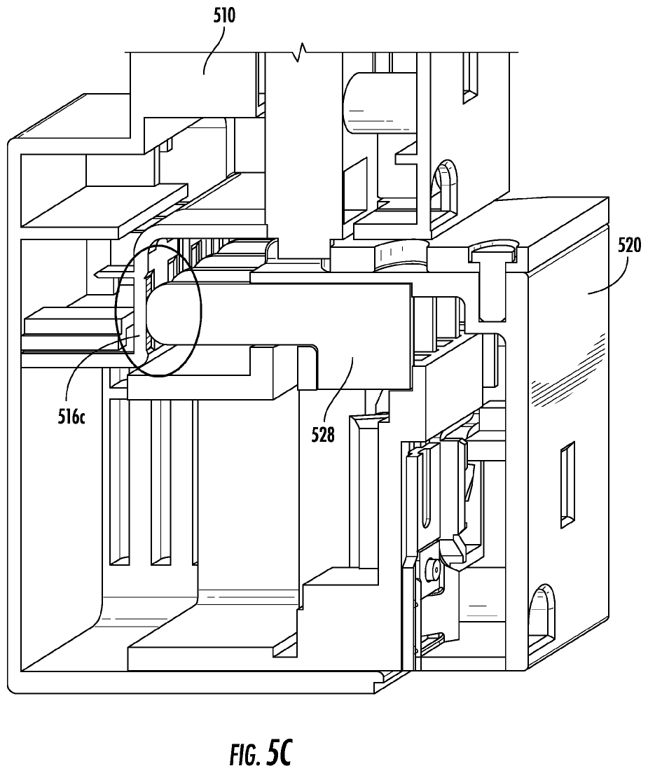

In some alternate embodiments, with reference to FIGS. 5A-5C, instead of using a separate or distinct projection, interrupter, or the like, the removeable module 520 may include a plurality of blades 528 extending therefrom. The base unit 510 may include a plurality of openings 516 for receiving the plurality of blades 528. That is, in use, a compatible base unit 510 and removeable module 520 may include corresponding openings 516 and blades 528 to enable the compatible removeable module 520 to be fully inserted into the interior cavity 512 of a compatible base unit 510. Thus arranged, in use, the blades 528 may be received within corresponding openings 516 formed in the base unit 510 to enable the removeable module 520 to make electrical connection with the electrical terminals positioned within the base unit 510.

However, in use, a non-compatible module may incorporate differently configured blades 528 such that receipt within openings 516 formed in a non-compatible base unit 510 is rendered impossible. For example, as illustrated, the removeable module 520 may include a plurality of blades 528 extending therefrom. As illustrated, in some embodiments, the removeable module 520 may include six blades 528 extending therefrom, although this is but one configuration and more or less blades may be utilized. In contrast, the non-compatible base unit 510 may include six openings 516, however, two of said openings 516c, 516d may be configured so that receipt of a blade 528 therein is rendered impossible. Thus arranged, in use, a non-compatible module including six blades 528 extending therefrom cannot be inserted, engaged, etc. with a non-compatible base unit including only four opened or available openings. More specifically, in use, the closed or non-existent openings 516c, 516d formed in the base unit 510 prevent a non-compatible removeable module 520 from being fully inserted into the interior cavity 512 of the base unit 510 by preventing receipt of the blades 528. As such, in use, these mechanisms prevent a user from installing an incompatible module into a non-compatible base unit thus enabling manufacturers to selectively control which specific modules can be installed, inserted, engaged with, coupled to, or the like, with what base units.

As generally illustrated, FIG. 5A illustrates, for example, a receptacle base unit 510 including a plurality of openings 516 with the third and fourth openings 516c, 516d closed or non-existent. FIG. 5B illustrates, for example, a non-compatible removeable module 520 including six blades 528 extending therefrom. As illustrated in FIG. 5C, the interaction between the closed or non-existent openings formed in the base unit and the blades extending from the module prevent the module from being fully inserted into the interior cavity of the base unit. It should be understood that the number of blades and corresponding openings, and the position and configuration (e.g., opened versus closed) can be altered as needed.

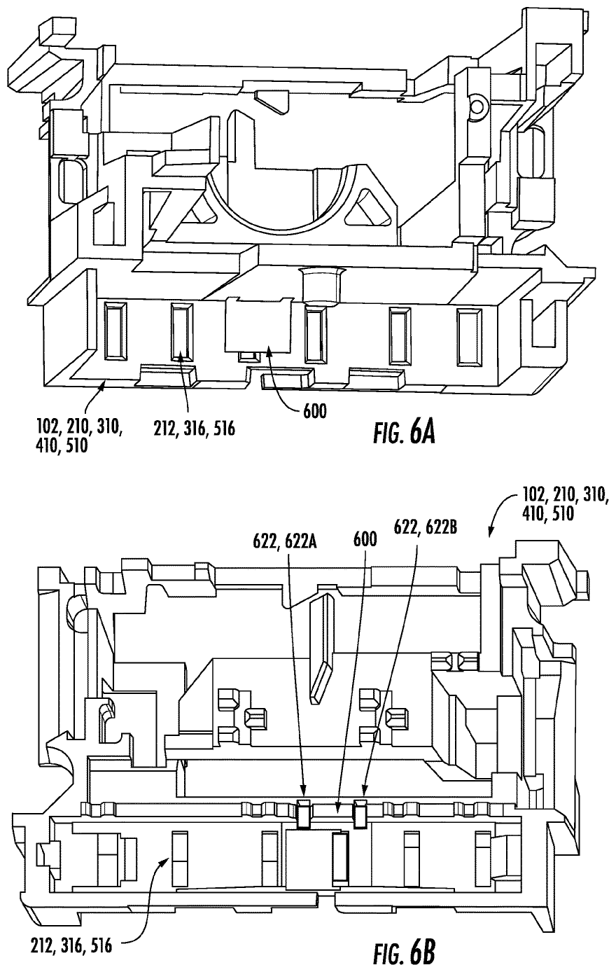

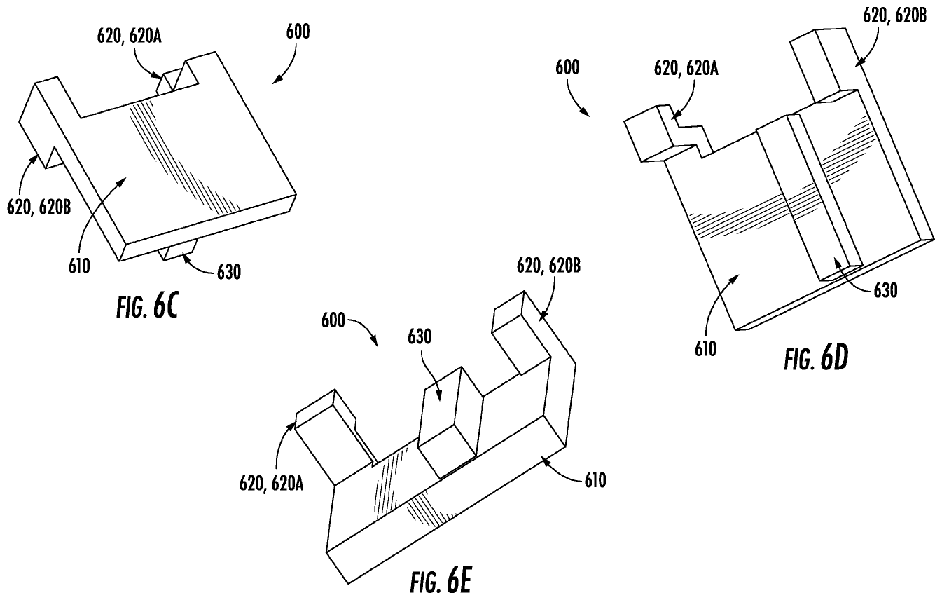

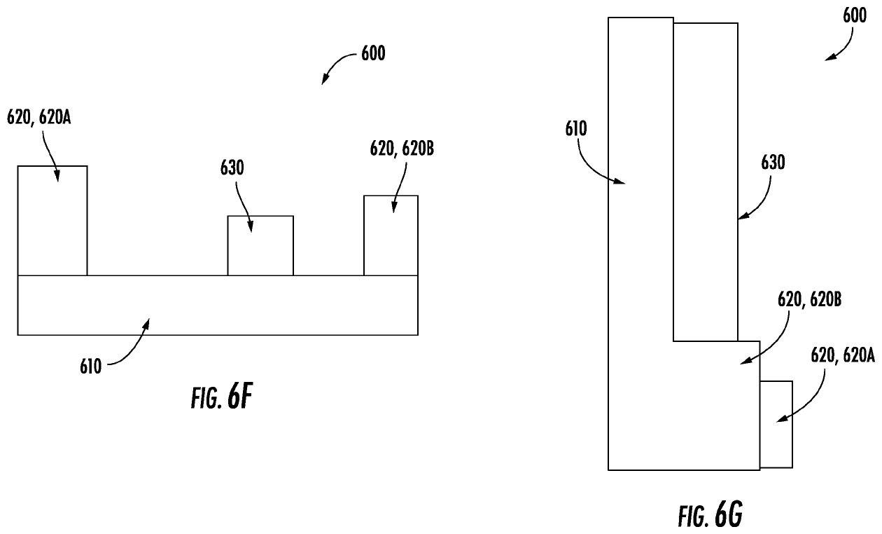

With reference to FIGS. 6A-6G, in accordance with one or more features of the present disclosure that may be used in combination with the previously described TR mechanisms or separately therefrom, the module rejection feature may be provided in the form of an insert, a plug, or a block 600 (terms used interchangeably herein without the intent to limit or distinguish). In use, the block 600 is arranged and configured to be inserted, received, etc. within one of the openings formed in a front facing surface of a base unit such as, for example, openings 212, 316 formed in base unit 102, 210, 310 as previously mentioned. Thus arranged, when inserted, the block 600 prevents insertion of a blade (or pin, projection, tab) extending from a removable module such as, for example, terminal contacts or blades 118, 322 as previously mentioned. For example, in some embodiments, the block 600 may be positioned within an opening arranged and configured to receive a blade extending from a receptacle module. In this manner, with the block 600 inserted into one of the openings of the base unit, a receptacle module is prevented from being inserted into the base unit. For example, in one exemplary method of use, a base unit may be installed within a wall, a ceiling, a floor, or the like. For example, the base unit may be installed adjacent wet areas such as, for example, adjacent sinks in a kitchen or bathroom. The base unit may include the block 600 positioned over the opening corresponding to the ground opening thereby preventing a conventional receptacle module from being inserted into the base unit. Positioning of the block 600 prevents an end user from using a standard receptacle module. Rather, incorporation of the block 600 requires the end user to insert a GFCI receptacle module into the base unit to avoid the block 600. Thus, base units incorporating the block 600 prevent end users from inserting a standard receptacle module into the base unit where, for example, a GFCI receptacle module is required. In use, the block 600 may be inserted by the manufacturer prior to delivery. Alternatively, and/or in addition, blocks 600 may be inserted (or removed) as needed by installers (e.g., electricians). Thus arranged, manufacturers and/or installers can selectively position one or more blocks 600 into the base unit to selectively control and/or permit insertion of compatible and non-compatible receptacle modules. As described above, the block 600 may be used to prevent an otherwise compatible module from being inserted into the base unit in applications where inappropriate. Alternatively, the block 600 may be used to prevent an incompatible module from being inserted into the base unit. For example, the block 600 may be used to prevent a dimmer module from being inserted into a base unit which does not connect to a lighting load. In another embodiment, the block 600 may be attached to the module as opposed to being attached to the base unit (e.g., restricting the module from being inserted into an otherwise compatible base unit.

In use, as previously mentioned, the block 600 is arranged and configured to be coupled to a base unit to prevent access to one or more of the openings formed in the base unit to thereby prevent insertion of blades or projections/tabs (conductive and/or non-conductive) of non-compatible modules. In use, the block 600 may have any suitable shape and configuration. In addition, the block 600 may be arranged and configured to engage the base unit in any suitable manner now know or hereafter developed including, for example, a press-fit, a snap-fit, or the like. With reference to FIGS. 6C-6G, an embodiment of a block 600 is illustrated. The block 600 includes a body portion 610 having one or more arms 620 arranged and configured to be received within one or more holes 622 (or recesses/cavities) formed in the base unit (e.g., a middle housing portion of the base unit being shown in FIGS. 6A and 6B). As illustrated, the block 600 may include first and second arms 620A, 620B arranged and configured to be received within first and second holes 622A, 622B formed in the base unit, although this is but one configuration and the block may include more or less arms.

As illustrated, in some embodiments, the first and second arms 620A, 620B may have different configurations. For example, as illustrated, the first arm 620A may have an “L-shaped” configuration while the second arm 620B may have a straight or blunt configuration, although this is but one configuration and the arms may have any suitable configuration. Moreover, in some embodiments, the first and second arms may have the same configuration (e.g., first and second arms may have identical configurations). In use, the first and second arms are arranged and configured to avoid interference with features formed on the base unit.

In addition, as illustrated, the body portion 610 of the block 600 may include a boss or protrusion 630 extending therefrom. In use, the boss 630 is arranged and configured to be received within the opening formed in a front facing surface of the base unit.

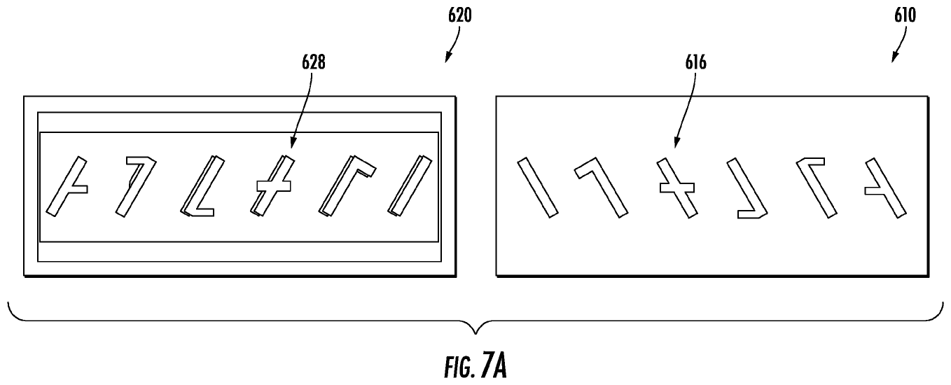

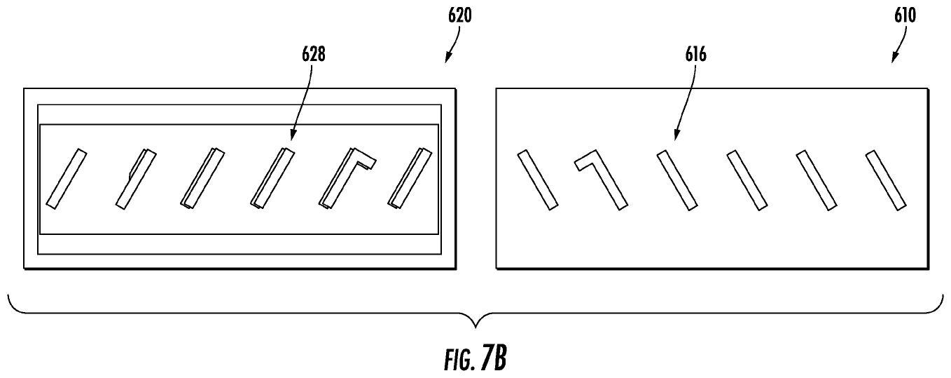

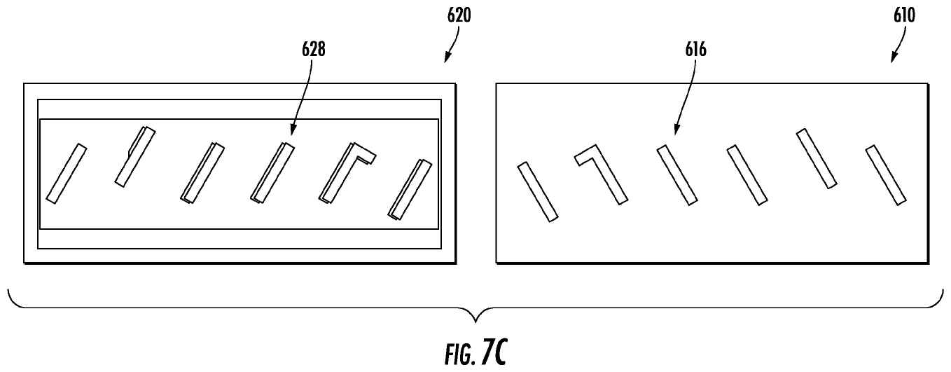

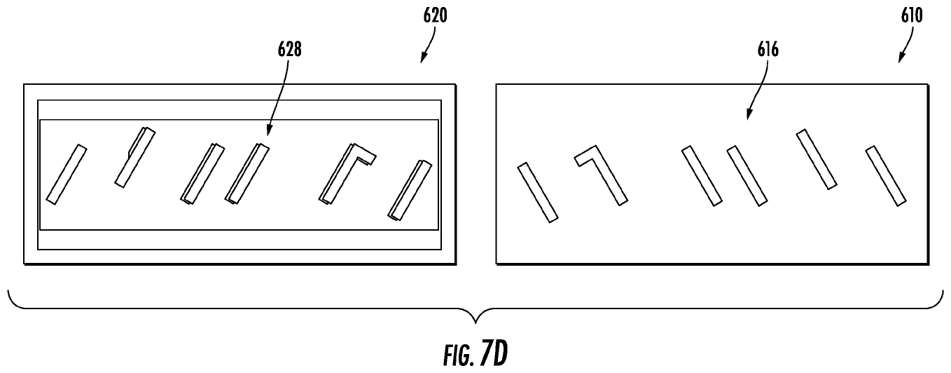

In addition, while the module rejection feature has been shown and described by varying the number of openings and blades, it should be appreciated that other mechanisms are envisioned including, for example, varying the shape of the blades and openings. That is, while particular configurations of blades and openings have been described herein for use with the TR mechanism and/or module rejection feature, it should be appreciated that the blades and corresponding openings may have alternate configurations to prevent, for example, insertion of one or more incompatible modules or objects into the base units. For example, with reference to FIGS. 7A-7D, the blades or terminals 628 of the modules 620 and the openings 616 formed in the base unit 610 may include variable offsets, distances, geometries, or combinations thereof. FIG. 7A illustrates alternate configurations of blade geometries and openings that may be utilized. FIG. 7B illustrates alternate configurations of blade geometries and openings that may be utilized, the blades and openings being angled or tilted. FIG. 7C illustrates alternate configurations of blade geometries and openings that may be utilized, the blades and openings being angled or tilted, and rotated. FIG. 7D illustrates alternate configurations of blade geometries and openings that may be utilized, the blades and openings being angled or tilted, rotated, and incorporate a change in pitch. It should be appreciated that while particular configurations of blades and corresponding openings are illustrated, there are but a few of the available configurations that may be utilized to, for example, prevent incompatible modules from being inserted into base units.

In some implementations, one or more components of the systems may be manufactured from any desired materials that may be suitable for a particular application (while complying with all applicable standards, codes, and regulations). For example, the base units, removable modules, TR mechanism, rejection features, etc. may be manufactured from plastic, composite, polymer, resin and/or any other suitable materials. Any electrical components, including any terminals, may be manufactured from metal, copper, and/or any other desired materials that may be used for conducting of electricity. The systems shown may be used for any desired purposes, e.g., light switches, electrical outlets, USB connections, Internet connections, etc.

The foregoing description has broad application. While the present disclosure refers to certain implementations, numerous modifications, alterations, and changes to the described implementations are possible without departing from the sphere and scope of the present disclosure, as defined in the appended claim(s). Accordingly, it is intended that the present disclosure not be limited to the described implementations. Rather these implementations should be considered as illustrative and not restrictive in character. All changes and modifications that come within the spirit of the current subject matter are to be considered within the scope of the disclosure. The present disclosure should be given the full scope defined by the language of the following claims, and equivalents thereof. The discussion of any implementation is meant only to be explanatory and is not intended to suggest that the scope of the disclosure, including the claims, is limited to these implementations. In other words, while illustrative implementations of the disclosure have been described in detail herein, it is to be understood that the inventive concepts may be otherwise variously embodied and employed, and that the appended claims are intended to be construed to include such variations, except as limited by the prior art. Unless otherwise defined, all technical terms used herein have the same meaning as commonly understood by one of ordinary skill in the art to which the disclosure belongs.

Directional terms such as top, bottom, superior, inferior, medial, lateral, anterior, posterior, proximal, distal, upper, lower, upward, downward, left, right, longitudinal, front, back, above, below, vertical, horizontal, radial, axial, clockwise, and counterclockwise) and the like may have been used herein. Such directional references are only used for identification purposes to aid the reader's understanding of the present disclosure. For example, the term “distal” may refer to the end farthest away from the medical professional/operator when introducing a device into a patient, while the term “proximal” may refer to the end closest to the medical professional when introducing a device into a patient. Such directional references do not necessarily create limitations, particularly as to the position, orientation, or use of this disclosure. As such, directional references should not be limited to specific coordinate orientations, distances, or sizes, but are used to describe relative positions referencing particular implementations. Such terms are not generally limiting to the scope of the claims made herein. Any implementation or feature of any section, portion, or any other component shown or particularly described in relation to various implementations of similar sections, portions, or components herein may be interchangeably applied to any other similar implementation or feature shown or described herein.

It should be understood that, as described herein, an “implementation” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated implementations are to be understood as examples (unless otherwise stated), and other manners of embodying the described concepts or features, such as may be understood by one of ordinary skill in the art upon learning the concepts or features from the present disclosure, are within the scope of the disclosure. Furthermore, references to “one implementation” of the present disclosure are not intended to be interpreted as excluding the existence of additional implementations that also incorporate the recited features.

In addition, it will be appreciated that while the figures may show one or more implementations of concepts or features together in a single implementation of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one implementation can be used separately, or with another implementation to yield a still further implementation. Thus, it is intended that the present subject matter covers such modifications and variations as come within the scope of the appended claims and their equivalents.

As used herein, an element or step recited in the singular and proceeded with the word “a” or “an” should be understood as not excluding plural elements or steps, unless such exclusion is explicitly recited. It will be further understood that the terms “includes” and/or “comprising,” or “includes” and/or “including” when used herein, specify the presence of stated features, regions, steps, elements and/or components, but do not preclude the presence or addition of one or more other features, regions, integers, steps, operations, elements, components and/or groups thereof.

The phrases “at least one,” “one or more,” and “and/or” as used herein, are open-ended expressions that are both conjunctive and disjunctive in operation. The terms “a” (or “an”), “one or more” and “at least one” can be used interchangeably herein.

Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

The foregoing discussion has been presented for purposes of illustration and description and is not intended to limit the disclosure to the form or forms disclosed herein. For example, various features of the disclosure are grouped together in one or more implementations or configurations for the purpose of streamlining the disclosure. However, it should be understood that various features of the certain implementations or configurations of the disclosure may be combined in alternate implementations or configurations. Moreover, the following claims are hereby incorporated into this detailed description by this reference, with each claim standing on its own as a separate implementation of the present disclosure.

1. A wiring device, comprising:
the base unit of claim 21;
the wiring device further comprising:
a removable module configured to be positioned at least partially within the interior cavity of the base unit, the removable module including a plurality of electrical terminals including the first electrical terminal, the second electrical terminal, and the third electrical terminal, wherein each of the plurality of electrical terminals of the removable module is configured to pass through a corresponding one of the plurality of openings of the base unit and into contact with a corresponding one of the plurality of electrical terminals positioned within the base unit.

2. The wiring device of claim 1, wherein the first surface comprises an angled surface with respect to a front surface of the slider such that contact with the first electrical terminal of the removable module causes the slider to move laterally relative to the front surface of the slider.

3. The wiring device of claim 21, wherein, in the first position, the second and third surfaces are inaccessible via the plurality of openings in the slider.

4. The wiring device of claim 1, wherein the second and third electrical terminals of the plurality of electrical terminals of the removable module contact the second and third surfaces simultaneously, respectively.

5. The wiring device of claim 1, wherein the first electrical terminal of the plurality of electrical terminals of the removable module comprises a ground terminal; and
wherein one of the second electrical terminal and the third electrical terminal of the removable module comprises a phase terminal, and the other of the second electrical terminal and the third electrical terminal comprises a neutral terminal.

6. (canceled)

7. (canceled)

8. The wiring device of claim 1, wherein the wiring device further includes first and second lock surfaces; and
wherein the first lock surface is configured to engage a first edge of the slider and the second lock surface is configured to engage a second edge of the slider.

9. The wiring device of claim 1, wherein the wiring device further includes first and second lock surfaces; and
wherein performance of the sequence of operations causes the slider to move without contacting the first and second lock surfaces.

10. The wiring device of claim 9, wherein, when the sequence of operations is not performed, the slider moves so that the slider contacts one of the first and second lock surfaces thereby preventing the slider from moving to the second position.

11. The wiring device of claim 10, wherein insertion of a compatible removable module into the interior cavity of the housing of the base unit results in performance of the sequence of operations.

12. The wiring device of claim 11, wherein insertion of one of a non-compatible removable module or a foreign object causes the slider to move into contact with one of the first and second lock surfaces.

13. The wiring device of claim 10, wherein movement of the slider comprises rotation.

14. (canceled)

15. The wiring device of claim 1, wherein the removable module includes a projection extending therefrom, the base unit includes an opening formed therein, wherein, for a compatible removable module, the projection is received by the opening formed in the base unit; and
wherein the opening formed in the base unit prevents insertion of a non-compatible removable module.

16. (canceled)

17. The base unit of the wiring device of claim 21, further comprising a block arranged and configured to engage one of the plurality of openings formed in the front facing surface of the base unit to prevent access to one or more of the plurality of openings.

18. The base unit of the wiring device of claim 17, wherein the block includes a body portion and a boss, wherein at least one of the body portion or the boss are arranged and configured to be received within the one or more of the plurality of openings; and
wherein the body portion further includes first and second arms arranged and configured to be received within first and second holes formed in the base unit.

19. (canceled)

20. (canceled)

21. A base unit of a wiring device, comprising:
a housing arranged and configured to be coupled within an electrical box within a building surface, the housing defining an interior cavity including a front facing surface including a plurality of openings, the housing further including a plurality of electrical terminals at least partially disposed within the housing, wherein each of the plurality of electrical terminals is accessible via a corresponding one of the plurality of openings, the housing further includes a slider including a plurality of openings, a first surface, a second surface, and a third surface;
wherein the interior cavity of the housing is arranged and configured to receive a removable module including a plurality of electrical terminals, wherein each of the plurality of electrical terminals of the removable module is configured to pass through a corresponding one of the plurality of openings formed in the front facing surface of the base unit to contact with a corresponding one of the plurality of electrical terminals positioned within the base unit; and
wherein the slider is positioned between the plurality of openings formed in the front facing surface of the interior cavity and the plurality of electrical terminals, the slider moveable between a first position, wherein the slider prevents access to the plurality of electrical terminals disposed in the base unit, and a second position, wherein the plurality of openings formed in the slider align with the plurality of openings formed in the front facing surface to enable the plurality of electrical terminals of the removable module to pass therethrough to contact the plurality of electrical terminals in the base unit;
wherein, the slider is configured to move from the first position to the second position in response to a sequence of operations, the sequence of operations including contacting via a first electrical terminal of the plurality of electrical terminals of the removable module the first surface of the slider to move the slider relative to the front facing surface by a predetermined distance, movement of the slider by the predetermined distance causing the second and third surfaces of the slider to become exposed, which enables contacting via a second electrical terminal of the plurality of electrical terminals of the removable module to contact the second surface and a third electrical terminal of the plurality of electrical terminals of the removable module to contact the third surface to move the slider to the second position.

22-24. (canceled)

25. The base unit of the wiring device of claim 21, wherein the slider includes first and second protrusions, the first and second protrusions including the first and second surfaces, respectively, the first and second protrusions being accessible via first and second openings, respectively, of the plurality of openings formed in the front facing surface.

26. The base unit of the wiring device of claim 25, wherein the first and second protrusions each include a ramped surface formed thereon configured to contact a corresponding ramped surface formed on first and second electrical terminals of the plurality of electrical terminals of the removable module.

27. The base unit of the wiring device of claim 25, wherein the third electrical terminal of the plurality of electrical terminals of the removable module is configured to extend horizontally relative to the first and second electrical terminals of the plurality of electrical terminals of the removable module.

28. The base unit of the wiring device of claim 27, wherein the slider includes a third protrusion including the third surface formed thereon, the third protrusion being accessible via a third opening of the plurality of openings formed in the front facing surface.

29. The base unit of the wiring device of claim 28, wherein the third protrusion includes a ramped surface formed thereon configured to contact a corresponding ramped surface formed on the third electrical terminal of the plurality of electrical terminals of the removable module.

30. The base unit of the wiring device of claim 28, wherein movement of the slider in a first direction causes the first and second protrusions to move out of contact with first and second abutting surfaces, respectively, formed on the front facing surface.

31. A wall-box mounted wiring device, comprising:
a base unit configured to be mounted within a wall-box, the base unit including a housing defining an interior cavity including a front facing surface having a plurality of base unit openings, the base unit being configured to receive a removable module at least partially within the interior cavity;
a plurality of electrical terminals at least partially disposed within the housing, wherein each of the plurality of electrical terminals is accessible via a corresponding one of the plurality of base unit openings; and
a slider having a plurality of slider openings and a plurality of slider contact surfaces arranged in a plurality of prescribed contact locations on the slider, each of the plurality of slider openings arranged and configured to be selectively aligned with a corresponding one of the plurality of base unit openings to permit the plurality of electrical terminals of the removable module to pass therethrough, the slider being movably positioned between the plurality of base unit openings and the plurality of electrical terminals, wherein the slider is moveable between a first position and a second position to selectively prevent and permit, respectively, the plurality of electrical terminals to pass therethrough,
a biasing member arranged and configured to bias the slider towards the first position when the removable module is not fully inserted into the interior cavity,
wherein in the first position at least one of the plurality of slider openings is not aligned with at least one of the plurality of base unit openings and in the second position each of the plurality of slider openings aligns with a corresponding one of the plurality of base unit openings,
wherein the slider is configured to be moved from the first position to the second position upon insertion of the removable module only if the plurality of electrical terminals are arranged and configured to fit through, and align with, the corresponding plurality of base unit openings and only upon the occurrence of at least two of the plurality of electrical terminals making physical contact with two of the corresponding prescribed contact locations of the plurality of prescribed contact locations in accordance with a prescribed contact sequence,
wherein the plurality of prescribed contact locations and the prescribed contact sequence are, defined by the arrangement and configuration of the:
plurality of base unit openings;
plurality of electrical terminals;
plurality of slider openings; and/or
plurality of slider contact surfaces,
wherein at least one of the plurality of prescribed contact surfaces is configured to interact with a corresponding first electrical terminal of the plurality of electrical terminals such that the slider is urged by such interaction to move from the first position to the second position when at least one other prescribed contact surface of the plurality of contact surfaces interacts with a corresponding second electrical terminal of the plurality of electrical terminals, wherein the first and second electrical terminals interact with corresponding prescribed contact surfaces in accordance with the prescribed contact sequence.

32. The wiring device in accordance with claim 31, wherein the prescribed contact sequence includes:
the first electrical terminal interacts with the at least one of the plurality of prescribed contact surfaces to move the slider relative to the front facing surface by a predetermined distance; and
movement of the slider by the predetermined distance causing the at least one other prescribed contact surface to become exposed so that the second electrical terminal of the plurality of electrical terminals contacts the at least one other prescribed contact surface to move the slider to the second position.

33. A wall-box mounted wiring device, comprising:
a housing having a front facing surface, wherein the front facing surface includes a plurality of wiring device openings;
an interior cavity, wherein the front facing surface is positioned within the interior cavity; and
at least partially enclosed portion including:
a plurality of electrical terminals, wherein each of the electrical terminals is aligned with a respective wiring device opening;
a slider positioned between the plurality of wiring device openings and the plurality of electrical terminals, the slider including:
a plurality of slider openings; and
a plurality of slider bearing surfaces, wherein each slider bearing surface is positioned at a respective bearing location on the slider, wherein the slider is moveable between:
a first position; and
a second position, wherein the slider is biased towards the first position;
the wiring device is configured to receive a removable module at least partially within the interior cavity, the removable module having a plurality of electrical terminals;
wherein when the slider in the first position, the slider prevents the electrical terminals from touching the plurality of terminals;
wherein when in the slider is in the second position, each of the slider openings is aligned with a respective wiring device opening, wherein the alignment enables each of the electrical terminals of the removable module to pass through a respective slider opening to touch a respective electrical terminal;
wherein the slider is configured to be moved from the first position to the second position only in response to a predetermined sequence, the predetermined sequence comprising:
each of the plurality of electrical terminals aligns with a respective wiring device opening;
a first electrical terminal of the plurality of electrical terminals exerts a first force on a first bearing surface of the plurality of bearing surfaces; and
a second electrical terminal of the plurality of electrical terminals exerts a second force on a second bearing surface of the plurality of bearing surfaces;
wherein the first and second forces are exerted simultaneously to cause the slider to move from the first position to the second position.

34. The wall-box mounted wiring device of claim 33, wherein the predetermined sequence further comprises:
the slider moving from the first position to an intermediate position in response to a third electrical terminal of the plurality of electrical terminals exerting a third force on a third bearing surface of the plurality of bearing surfaces.

35. The wall-box mounted wiring device of claim 34, wherein the slider moving from the intermediate position to the second position in response to a fourth electrical terminal of the plurality of electrical terminals exerting a fourth force on a fourth bearing surface of the plurality of bearing surfaces.

36. The wall-box mounted wiring device of claim 34, wherein the movement between the first position and the intermediate position occurs in a first direction and the movement between the intermediate position to the second position occurs in a second direction, wherein the first and second directions are parallel or perpendicular to each other.
